(19) United States
(12) Patent Application Publication
(10) Pub. No.: US 2025/0273145 A1
(43) Pub. Date: Aug. 28, 2025

(54) PIXEL, DISPLAY APPARATUS INCLUDING THE SAME AND DISPLAY APPARATUS INCLUDING THE SAME

(71) Applicant: Samsung Display Co., LTD., Yongin-si (KR)

(72) Inventor: KyeongMin PARK, Yongin-si (KR)

(21) Appl. No.: 18/976,719

(22) Filed: Dec. 11, 2024

(30) Foreign Application Priority Data
Feb. 26, 2024 (KR) 10-2024-0027599

(51) Int. Cl. G09G 3/3233; G09G 3/3266; G09G 3/3291

(52) U.S. Cl. CPC G09G 3/3233; G09G 3/3266; G09G 3/3291; G09G 2310/08

(57) ABSTRACT

A pixel includes a first switching element including a control electrode connected to a first node, a first electrode connected to a second node and a second electrode connected to a third node, a second switching element including a control electrode connected to the second node, a first electrode connected to a fifth node and a second electrode connected to the second node, a third switching element including a control electrode which receives a writing gate signal, a first electrode which receives a data voltage and a second electrode connected to the first node, a first capacitor including a first electrode connected to the first node and a second electrode connected to a fourth node, a second capacitor connected to the fourth node, a fourth switching element which receives an initialization gate signal, a fourth switching element connected to the fourth node and a light emitting element which emits light.

This application claims priority to Korean Patent Application No. 10-2024-0027599, filed on Feb. 26, 2024, and all the benefits accruing therefrom under 35 U.S.C. § 119, the content of which in its entirety is herein incorporated by reference.

### BACKGROUND

### 1. Field

Embodiments of the invention relate to a pixel, a display apparatus including the pixel and an electronic apparatus including the display apparatus. More particularly, embodiments of the invention relate to a pixel including a second switching element having a diode-connection, a first capacitor and a second capacitor, thereby increasing a data swing range and enhancing a uniformity, and a display apparatus including the pixel.

### 2. Description of the Related Art

Generally, a display apparatus includes a display panel and a display panel driver. The display panel may include a plurality of gate lines, a plurality of data lines, a plurality of emission lines and a plurality of pixels. The display panel driver may include a gate driver, a data driver, an emission driver and a driving controller. The gate driver may output gate signals to the gate lines. The data driver may output data voltages to the data lines. The emission driver may output emission signals to the emission lines. The driving may controller control the gate driver, the data driver and the emission driver.

### SUMMARY

In a display device, a display quality of a display panel may be deteriorated due to a variation of a threshold voltage of a driving switching element and a variation of a threshold voltage of a light emitting element. In addition, when a data swing range is little, a grayscale value may not be represented precisely such that the display quality of the display panel may be deteriorated.

Embodiments of the invention provide a pixel including a second switching element having a diode-connection, a first capacitor and a second capacitor, and accordingly increasing a data swing range and enhancing a uniformity.

Embodiments of the invention provide a display apparatus including the pixel.

Embodiments of the invention provide an electronic apparatus including the display apparatus.

In an embodiment of a pixel according to the invention, the pixel includes a first switching element, a second switching element, a third switching element, a first capacitor, a second capacitor, a fourth switching element and a light emitting element. In such an embodiment, the first switching element includes a control electrode connected to a first node, a first electrode connected to a second node and a second electrode connected to a third node. In such an embodiment, the second switching element includes a control electrode connected to the second node, a first electrode connected to a fifth node and a second electrode connected to the second node. In such an embodiment, the third switching element includes a control electrode which receives a writing gate signal, a first electrode which receives a data voltage and a second electrode connected to the first node. In such an embodiment, the first capacitor includes a first electrode connected to the first node and a second electrode connected to a fourth node. In such an embodiment, the second capacitor is connected to the fourth node. In such an embodiment, the fourth switching element is which receives an initialization gate signal. In such an embodiment, the fourth switching element is connected to the fourth node. In such an embodiment, the light emitting element emits light based on a driving current flowing thereto through the first switching element.

In an embodiment, the fourth switching element may include a control electrode which receives the initialization gate signal, a first electrode which receives a first power voltage and a second electrode connected to the fourth node.

In an embodiment, the second capacitor may include a first electrode connected to the fourth node and a second electrode connected to the fifth node.

In an embodiment, the second capacitor may include a first electrode connected to the fourth node and a second electrode connected to the second node.

In an embodiment, the fourth switching element may include a control electrode which receives the initialization gate signal, a first electrode connected to the fifth node and a second electrode connected to the fourth node.

In an embodiment, the second capacitor may include a first electrode connected to the fourth node and a second electrode connected to the fifth node.

In an embodiment, the second capacitor may include a first electrode connected to the fourth node and a second electrode connected to the second node.

In an embodiment, the fourth switching element may include a control electrode which receives the initialization gate signal, a first electrode connected to the second node and a second electrode connected to the fourth node.

In an embodiment, the pixel may further include a fifth switching element including a control electrode which receives an emission signal, a first electrode which receives a first power voltage and a second electrode connected to the fifth node.

In an embodiment, the pixel may further include a sixth switching element including a control electrode which receives a light emitting element initialization gate signal, a first electrode which receives an initialization voltage and a second electrode connected to the third node.

In an embodiment, the pixel may further include a fifth switching element including a control electrode which receives an emission signal, a first electrode which receives a first power voltage and a second electrode connected to the fifth node. In such an embodiment, the first switching element, the second switching element, the third switching element, the fourth switching element, the fifth switching element and the sixth switching element may be P-type transistors.

In an embodiment, breakdown voltages of the first switching element and the sixth switching element may be greater than breakdown voltages of the second switching element, the third switching element, the fourth switching element and the fifth switching element.

In an embodiment, the pixel may further include a fifth switching element including a control electrode which receives an emission signal, a first electrode which receives a first power voltage and a second electrode connected to the fifth node. In such an embodiment, the first switching element, the second switching element, the third switching element, the fourth switching element and the fifth switching element may be P-type transistors, and the sixth switching element may be an N-type transistor.

In an embodiment, the pixel may further include a fifth switching element including a control electrode which receives an emission signal, a first electrode which receives a first power voltage and a second electrode connected to the fifth node. In such an embodiment, the initialization gate signal may have an active level in a first period, the writing gate signal may have an active level in the first period, the emission signal may have an active level in the first period, the light emitting element initialization gate signal may have an active level in the first period and the data voltage may have a reference voltage in the first period. In such an embodiment, the initialization gate signal may have an inactive level in a second period subsequent to the first period, the writing gate signal may have the active level in the second period, the emission signal may have an inactive level in the second period, the light emitting element initialization gate signal may have the active level in the second period and the data voltage may have a present grayscale data voltage in the second period. In such an embodiment, the initialization gate signal may have the inactive level in a third period subsequent to the second period, the writing gate signal may have an inactive level in the third period, the emission signal may have the active level in the third period and the light emitting element initialization gate signal may have an inactive level in the third period.

In an embodiment, the pixel may further include a fifth switching element including a control electrode which receives an emission signal, a first electrode which receives a first power voltage and a second electrode connected to the fifth node. In such an embodiment, the initialization gate signal may have an active level in a first period, the writing gate signal may have an active level in the first period, the emission signal may have an active level in the first period and the light emitting element initialization gate signal may have an active level in the first period. In such an embodiment, the initialization gate signal may have an inactive level in a second period subsequent to the first period, the writing gate signal may have the active level in the second period, the emission signal may have an inactive level in the second period and the light emitting element initialization gate signal may have the active level in the second period. In such an embodiment, the initialization gate signal has the inactive level in a third period subsequent to the second period, the writing gate signal may have an inactive level in the third period, the emission signal may be changed from the inactive level to the active level at a first time point subsequent to a start point of the third period and the light emitting element initialization gate signal may be changed from the active level to an inactive level at a second time point subsequent to the start point of the third period.

In an embodiment, the pixel may further include a fifth switching element including a control electrode which receives an emission signal, a first electrode which receives a first power voltage and a second electrode connected to the fifth node. In such an embodiment, the initialization gate signal may have an active level in a first period, the writing gate signal may have an active level in the first period, the emission signal may have an active level in the first period, the light emitting element initialization gate signal may have an active level in the first period and the data voltage may have a present grayscale data voltage in the first period. In such an embodiment, the initialization gate signal may have an inactive level in a second period subsequent to the first period, the writing gate signal may have the active level in the second period, the emission signal may have an inactive level in the second period, the light emitting element initialization gate signal may have the active level in the second period and the data voltage may have the present grayscale data voltage in the second period. In such an embodiment, the initialization gate signal may have the inactive level in a third period subsequent to the second period, the writing gate signal may have an inactive level in the third period, the emission signal may have the active level in the third period and the light emitting element initialization gate signal may have an inactive level in the third period.

In an embodiment, when I_{d} indicates a current flowing through the light emitting element, μₚ indicates a mobility of the first switching element, Cₒₓ indicates a capacitance of the first switching element, W/L indicates a ratio of a width and a length of a channel of the first switching element, VDD indicates a first power voltage, V_{dsat2} indicates a saturation voltage of the second switching element, Vₜₕ₂ indicates a threshold voltage of the second switching element, C₁ indicates a capacitance of the first capacitor, C₂ indicates a capacitance of the second capacitor, V_{DATA} indicates the data voltage, V_{REF} indicates a reference voltage, Vₜₕ₁ indicates a threshold voltage of the first switching element, gₘ indicates a trans-conductance of the first switching element and R_{dio} indicates a resistance of the second switching element,

$${I}_{d} = \frac{1}{2} {μ}_{p} {C}_{ox} \frac{W}{L} {( \frac{VDD - {V}_{dsat 2} - \vert {V}_{th 2} \vert - \frac{{C}_{1}}{{C}_{1} + {C}_{2}} \cdot ( {V}_{DATA} - {V}_{REF} )}{1 + {g}_{m} {R}_{dio}} - \vert {V}_{th 1} \vert )}^{2}$$

may be satisfied.

In an embodiment, the pixel may further include a seventh switching element including a control electrode which receives a second initialization gate signal, a first electrode which receives a reference voltage and a second electrode connected to the first node.

In an embodiment, the pixel may further include a fifth switching element including a control electrode which receives an emission signal, a first electrode which receives a first power voltage and a second electrode connected to the fifth node and a sixth switching element including a control electrode which receives a light emitting element initialization gate signal, a first electrode which receives an initialization voltage and a second electrode connected to the third node. In such an embodiment, the initialization gate signal may have an active level in a first period, the second initialization gate signal may have an active level in the first period, the writing gate signal may have an active level in the first period, the emission signal may have an active level in the first period, the light emitting element initialization gate signal may have an active level in the first period and the data voltage may have the reference voltage in the first period. In such an embodiment, the initialization gate signal may have an inactive level in a second period subsequent to the first period, the second initialization gate signal may have an inactive level in the second period, the writing gate signal may have the active level in the second period, the emission signal may have an inactive level in the second period, the light emitting element initialization gate signal may have the active level in the second period and the data voltage may have a present grayscale data voltage in the second period. In such an embodiment, the initialization gate signal may have the inactive level in a third period subsequent to the second period, the second initialization gate signal may have the inactive level in the third period, the writing gate signal may have an inactive level in the third period, the emission signal may have the active level in the third period and the light emitting element initialization gate signal may have an inactive level in the third period.

In an embodiment of a display apparatus according to the invention, the display apparatus includes a display panel, a gate driver and a data driver. In such an embodiment, the display panel includes a pixel. In such an embodiment, the gate driver outputs a gate signal to the pixel. In such an embodiment, the data driver outputs a data voltage to the pixel. In such an embodiment, the pixel includes a first switching element, a second switching element, a third switching element, a first capacitor, a second capacitor, a fourth switching element and a light emitting element. In such an embodiment, the first switching element includes a control electrode connected to a first node, a first electrode connected to a second node and a second electrode connected to a third node. In such an embodiment, the second switching element includes a control electrode connected to the second node, a first electrode connected to a fifth node and a second electrode connected to the second node. In such an embodiment, the third switching element includes a control electrode which receives a writing gate signal, a first electrode which receives the data voltage and a second electrode connected to the first node. In such an embodiment, the first capacitor includes a first electrode connected to the first node and a second electrode connected to a fourth node. In such an embodiment, the second capacitor is connected to the fourth node. In such an embodiment, the fourth switching element receives an initialization gate signal. In such an embodiment, the fourth switching element is connected to the fourth node. In such an embodiment, the light emitting element is configured to emit light based on a driving current flowing thereto through the first switching element.

In an embodiment of an electronic apparatus according to the invention, the electronic apparatus includes a display panel, a gate driver, a data driver, a driving controller and a processor. In such an embodiment, the display panel includes a pixel. In such an embodiment, the gate driver outputs a gate signal to the pixel. In such an embodiment, the data driver outputs a data voltage to the pixel. In such an embodiment, the driving controller controls the gate driver and the data driver. In such an embodiment, the processor outputs input image data and an input control signal. In such an embodiment, the pixel includes a first switching element, a second switching element, a third switching element, a first capacitor, a second capacitor, a fourth switching element and a light emitting element. In such an embodiment, the first switching element includes a control electrode connected to a first node, a first electrode connected to a second node and a second electrode connected to a third node. In such an embodiment, the second switching element includes a control electrode connected to the second node, a first electrode connected to a fifth node and a second electrode connected to the second node. In such an embodiment, the third switching element includes a control electrode which receives a writing gate signal, a first electrode which receives the data voltage and a second electrode connected to the first node. In such an embodiment, the first capacitor includes a first electrode connected to the first node and a second electrode connected to a fourth node. In such an embodiment, the second capacitor is connected to the fourth node. In such an embodiment, the fourth switching element receives an initialization gate signal. In such an embodiment, the fourth switching element is connected to the fourth node. In such an embodiment, the light emitting element is configured to emit light based on a driving current flowing thereto through the first switching element.

According to embodiments of the pixel, the display apparatus including the pixel and the electronic apparatus including the display apparatus, the pixel may include the second switching element having a diode-connection, the first capacitor and the second capacitor.

In such embodiments, the pixel may include the second switching element having the diode-connection such that a variation of a threshold voltage of the driving switching element and a variation of a threshold voltage of the light emitting element may be compensated.

In addition, the data swing range which is wider than the data range of the driving switching element may be obtained due to a linearization effect of the second switching element. In addition, the data voltage is distributed by charge distribution of the first capacitor and the second capacitor such that the data swing range may be further expanded.

In such embodiments, the first switching element and the sixth switching element are implemented as high-voltage MOSFETs and the second switching element, the third switching element, the fourth switching element and the fifth switching element are implemented as medium-voltage MOSFETs such that an area of the pixel may be decreased and accordingly, a resolution of the display panel may be increased.

In addition, the second switching element is implemented as a medium-voltage MOSFET such that a voltage margin may be further obtained by a threshold voltage of the second switching element.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram illustrating a display apparatus according to an embodiment of the invention;

FIG. 2 is a circuit diagram illustrating a pixel of a display panel of FIG. 1;

FIG. 3 is a timing diagram illustrating an example of input signals applied to the pixel of FIG. 2;

FIG. 4 is a timing diagram illustrating an example of input signals applied to the pixel of FIG. 2;

FIG. 5 is a timing diagram illustrating an example of input signals applied to the pixel of FIG. 2;

FIGS. 6 to 8 are graphs illustrating a compensation of a threshold voltage of a first switching element and a compensation of a threshold voltage of a light emitting element by a second switching element of FIG. 2;

FIG. 9 is a graph illustrating an increase of a data swing range and an enhancement of a uniformity by the second switching element of FIG. 2;

FIG. 10 is a circuit diagram illustrating a pixel of a display panel of a display apparatus according to an embodiment of the invention;

FIG. 11 is a circuit diagram illustrating a pixel of a display panel of a display apparatus according to an embodiment of the invention;

FIG. 12 is a circuit diagram illustrating a pixel of a display panel of a display apparatus according to an embodiment of the invention;

FIG. 13 is a circuit diagram illustrating a pixel of a display panel of a display apparatus according to an embodiment of the invention;

FIG. 14 is a circuit diagram illustrating a pixel of a display panel of a display apparatus according to an embodiment of the invention;

FIG. 15 is a timing diagram illustrating an example of input signals applied to the pixel of FIG. 14;

FIG. 16 is a circuit diagram illustrating a pixel of a display panel of a display apparatus according to an embodiment of the invention;

FIG. 17 is a circuit diagram illustrating a pixel of a display panel of a display apparatus according to an embodiment of the invention;

FIG. 18 is a circuit diagram illustrating a pixel of a display panel of a display apparatus according to an embodiment of the invention;

FIG. 19 is a circuit diagram illustrating a pixel of a display panel of a display apparatus according to an embodiment of the invention;

FIG. 20 is a circuit diagram illustrating a pixel of a display panel of a display apparatus according to an embodiment of the invention;

FIG. 21 is a timing diagram illustrating an example of input signals applied to the pixel of FIG. 20;

FIG. 22 is a circuit diagram illustrating a pixel of a display panel of a display apparatus according to an embodiment of the invention;

FIG. 23 is a circuit diagram illustrating a pixel of a display panel of a display apparatus according to an embodiment of the invention;

FIG. 24 is a circuit diagram illustrating a pixel of a display panel of a display apparatus according to an embodiment of the invention;

FIG. 25 is a circuit diagram illustrating a pixel of a display panel of a display apparatus according to an embodiment of the invention;

FIG. 26 is a circuit diagram illustrating a pixel of a display panel of a display apparatus according to an embodiment of the invention;

FIG. 27 is a timing diagram illustrating an example of input signals applied to the pixel of FIG. 26;

FIG. 28 is a circuit diagram illustrating a pixel of a display panel of a display apparatus according to an embodiment of the invention;

FIG. 29 is a circuit diagram illustrating a pixel of a display panel of a display apparatus according to an embodiment of the invention;

FIG. 30 is a circuit diagram illustrating a pixel of a display panel of a display apparatus according to an embodiment of the invention;

FIG. 31 is a circuit diagram illustrating a pixel of a display panel of a display apparatus according to an embodiment of the invention;

FIG. 32 is a block diagram illustrating an electronic apparatus according to an embodiment of the invention;

FIG. 33 is a diagram illustrating an example in which the electronic apparatus of FIG. 32 is implemented as a virtual reality display system; and

FIG. 34 is a diagram illustrating an example in which the electronic apparatus of FIG. 32 is implemented as a smart phone.

### DETAILED DESCRIPTION INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the invention will be explained in detail with reference to the accompanying drawings.

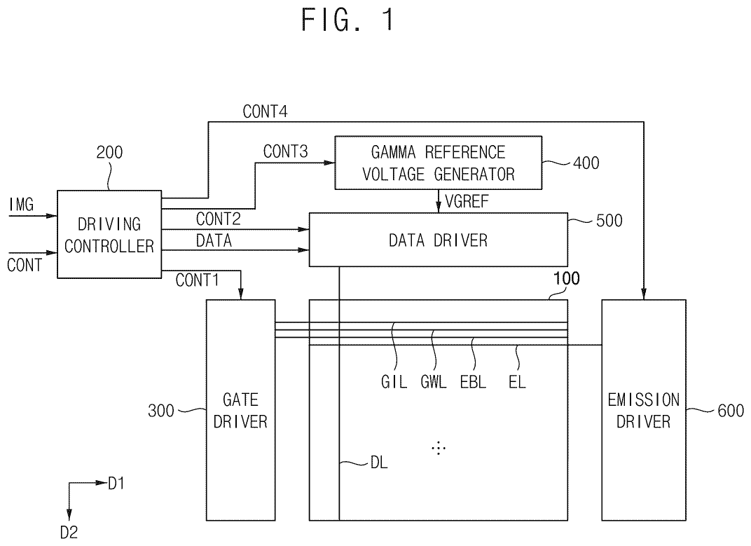

FIG. 1 is a block diagram illustrating a display apparatus according to an embodiment of the invention.

Referring to FIG. 1, an embodiment of the display apparatus includes a display panel 100 and a display panel driver. The display panel driver includes a driving controller 200, a gate driver 300, a gamma reference voltage generator 400, a data driver 500 and an emission driver 600.

In an embodiment, the display panel 100 includes a display region, on which an image is displayed, and a peripheral (or non-display) region adjacent to the display region.

The display panel 100 includes a plurality of gate lines GIL, GWL and EBL, a plurality of data lines DL, a plurality of emission lines EL and a plurality of pixels electrically connected to the gate lines GIL, GWL and EBL, the data lines DL and the emission lines EL. The gate lines GIL, GWL and EBL may extend in a first direction D1, the data lines DL may extend in a second direction D2 crossing the first direction D1 and the emission lines EL may extend in the first direction D1.

The driving controller 200 receives input image data IMG and an input control signal CONT from an external apparatus (e.g. a processor). In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals driving the gate lines GIL, GWL and EBL in response to the first control signal CONT1 received from the driving controller 200. The gate driver 300 may output the gate signals to the gate lines GIL, GWL and EBL.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

The emission driver 600 generates emission signals to drive the emission lines EL in response to the fourth control signal CONT4 received from the driving controller 200. The emission driver 600 may output the emission signals to the emission lines EL.

Although an embodiment where the gate driver 300 is disposed at a first side of the display panel 100 and the emission driver 600 is disposed at a second side of the display panel 100 opposite to the first side is shown in FIG. 1 for convenience of illustration and description, the invention may not be limited thereto. In another embodiment, for example, both of the gate driver 300 and the emission driver 600 may be disposed at the first side of the display panel 100. In another embodiment, for example, both of the gate driver 300 and the emission driver 600 may be disposed at both sides (e.g. the first side and the second side) of the display panel 100. In another embodiment, for example, the gate driver 300 and the emission driver 600 may be integrally formed as a single chip.

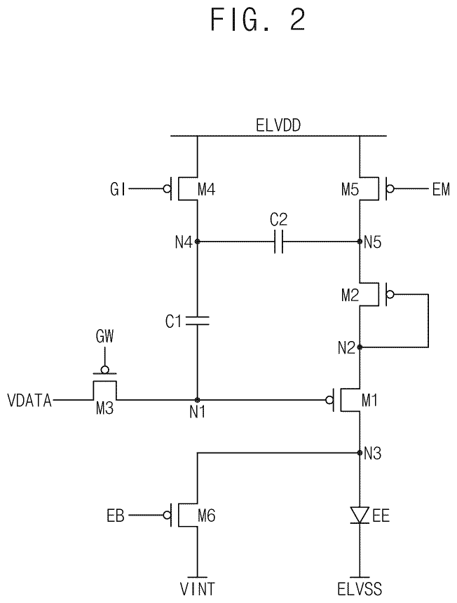

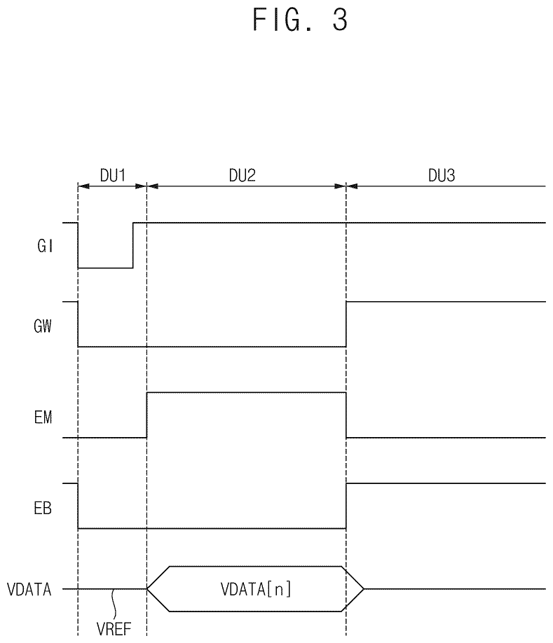

FIG. 2 is a circuit diagram illustrating a pixel of the display panel 100 of FIG. 1. FIG. 3 is a timing diagram illustrating an example of input signals applied to the pixel of FIG. 2.

Referring to FIGS. 1 to 3, an embodiment of the display panel 100 includes the plurality of the pixels. Each pixel includes a light emitting element EE. In an embodiment, for example, the light emitting element EE may be a micro organic light emitting diode (Micro-OLED).

In an embodiment, for example, the display apparatus may be a micro display apparatus including the micro organic light emitting diode (Micro-OLED). In an embodiment, for example, the pixel may be formed on a silicon substrate. In an embodiment, for example, the display apparatus may be a micro display apparatus including the pixels formed on the silicon substrate.

The pixel receives a writing gate signal GW, an initialization gate signal GI, a light emitting element initialization gate signal EB, the data voltage VDATA and the emission signal EM, and the light emitting element EE of the pixel emits light corresponding to the level of the data voltage VDATA to display the image.

The pixel includes a first switching element M1, a second switching element M2, a third switching element M3, a first capacitor C1, a second capacitor C2, a fourth switching element M4 and the light emitting element EE.

The first switching element M1 includes a control electrode connected to a first node N1, a first electrode connected to a second node N2 and a second electrode connected to a third node N3. The first switching element M1 may be referred to as a driving switching element.

The second switching element M2 includes a control electrode connected to the second node N2, a first electrode connected to a fifth node N5 and a second electrode connected to the second node N2. The second switching element M2 may have a diode-connection (or connected in a diode manner or form).

The third switching element M3 includes a control electrode that receives the writing gate signal GW, a first electrode that receives the data voltage VDATA and a second electrode connected to the first node N1.

The first capacitor C1 includes a first electrode connected to the first node N1 and a second electrode connected to a fourth node N4. The second capacitor C2 is connected to the fourth node N4. In an embodiment, the second capacitor C2 may include a first electrode connected to the fourth node N4 and a second electrode connected to the fifth node N5.

The fourth switching element M4 receives the initialization gate signal GI and connected to the fourth node N4. In an embodiment, the fourth switching element M4 may include a control electrode that receives the initialization gate signal GI, a first electrode that receives a first power voltage ELVDD and a second electrode connected to the fourth node N4.

The light emitting element EE emits light based on a driving current flowing through the first switching element M1. In an embodiment, for example, the light emitting element EE may include a first electrode connected to the third node N3 and a second electrode that receives a second power voltage ELVSS. In an embodiment, for example, the first electrode of the light emitting element EE may be an anode electrode, and the second electrode of the light emitting element EE may be a cathode electrode.

In an embodiment, for example, the first power voltage ELVDD may be a high power voltage for emitting the light emitting element EE and the second power voltage ELVSS may be a low power voltage for emitting the light emitting element EE. The first power voltage ELVDD may be greater than the second power voltage ELVSS, that is, a voltage level of the first power voltage ELVDD may be higher than a voltage level of the second power voltage ELVSS.

The pixel may further include a fifth switching element M5 including a control electrode that receives the emission signal EM, a first electrode that receives the first power voltage ELVDD and a second electrode connected to the fifth node N5.

The pixel may further include a sixth switching element M6 including a control electrode that receives the light emitting element initialization gate signal EB, a first electrode that receives an initialization voltage VINT and a second electrode connected to the third node N3.

In an embodiment, the first switching element M1, the second switching element M2, the third switching element M3, the fourth switching element M4, the fifth switching element M5 and the sixth switching element M6 may be P-type transistors. In an embodiment, for example, the first switching element M1, the second switching element M2, the third switching element M3, the fourth switching element M4, the fifth switching element M5 and the sixth switching element M6 may be low temperature polysilicon (LTPS) thin film transistors.

Breakdown voltages of the first switching element M1 and the sixth switching element M6 may be greater than breakdown voltages of the second switching element M2, the third switching element M3, the fourth switching element M4 and the fifth switching element M5. The breakdown voltage may mean a maximum voltage that a gate-source voltage, a gate-drain voltage, a gate-body voltage, a drain-source voltage and a drain-body voltage of the switching element are not allowed to exceed to normally operate.

In an embodiment, for example, the first switching element M1 and the sixth switching element M6 may be high-voltage metal-oxide-semiconductor field-effect transistors (MOSFETs). The breakdown voltages of the first switching element M1 and the sixth switching element M6 may be about 6 volts (V), about 8 V or about 10 V, for example.

In an embodiment, for example, the second switching element M2, the third switching element M3, the fourth switching element M4 and the fifth switching element M5 may be medium-voltage MOSFETs. The breakdown voltages of the second switching element M2, the third switching element M3, the fourth switching element M4 and the fifth switching element M5 may be about 3.5 V or about 5 V.

In an embodiment, the first switching element M1 and the sixth switching element M6 are implemented as the high-voltage MOSFETs and the second switching element M2, the third switching element M3, the fourth switching element M4 and the fifth switching element M5 are implemented as the medium-voltage MOSFETs such that an area of the pixel may be decreased compared to a case where the first to sixth switching elements M1 to M6 are all implemented as the high-voltage MOSFETs and accordingly, in such an embodiment, a resolution of the display panel 100 may be increased.

The first switching element M1 and the sixth switching element M6 are switching elements directly connected to the anode electrode of the light emitting element EE without any intervening element (a transistor or a capacitor) connected therebetween so that the first switching element M1 and the sixth switching element M6 may be implemented as the high-voltage MOSFETs for a reliability and a stability of a pixel circuit.

As shown in FIG. 3, in a first period DU1, the initialization gate signal GI may have an active level, the writing gate signal GW may have an active level, the emission signal EM may have an active level, the light emitting element initialization gate signal EB may have an active level and the data voltage VDATA may have a reference voltage VREF. The first period DU1 may be an initialization period.

FIG. 3 shows an embodiment where the switching elements that receive the signals are P-type transistors, such that an active level may be a low level and an inactive level may be a high level. In another embodiment, where the switching elements that receives the signals are N-type transistors, an active level may be a high level and an inactive level may be a low level.

In the first period DU1, all of the first to sixth switching elements M1 to M6 may be turned on. In the first period DU1, the first power voltage ELVDD may be applied to the fourth node N4 by the turned-on fourth switching element M4 and the reference voltage VREF may be applied to the first node N4 by the turned-on third switching element M3. In addition, in the first period DU1, the first power voltage ELVDD may be applied to the fifth node N5 by the turned-on fifth switching element M5. In addition, in the first period DU1, the initialization voltage VINT may be applied to the third node N3 by the turned-on sixth switching element M6.

In the first period DU1, even though the first switching element M1 is turned on, the light emitting element EE may not emit light by a level of the initialization voltage VINT.

In a second period DU2 subsequent to the first period DU1, the initialization gate signal GI may have an inactive level, the writing gate signal GW may have the active level, the emission signal EM may have an inactive level, the light emitting element initialization gate signal EB may have the active level and the data voltage VDATA may have a present grayscale data voltage VDATA[n]. The second period DU2 may be a data writing period.

In the second period DU2, the third switching element M3 may be turned on by the writing gate signal GW such that the present grayscale data voltage VDATA[n] may be applied to the first node N1.

In the second period DU2, the sixth switching element M6 may be turned on by the light emitting element initialization gate signal EB such that the initialization voltage VINT may be applied to the third node N3.

In a third period DU3 subsequent to the second period DU2, the initialization gate signal GI may have the inactive level, the writing gate signal GW may have an inactive level, the emission signal EM may have the active level and the light emitting element initialization gate signal EB may have an inactive level. The third period DU3 may be a light emitting period.

In the third period DU3, the fifth switching element M5, the second switching element M2 and the first switching element M1 may be turned on and the driving current may flow through the fifth switching element M5, the second switching element M2, the first switching element M1 and the light emitting element EE such that the light emitting element EE may emit light.

When I_{d} indicates a current flowing through the light emitting element EE, μₚ indicates a mobility of the first switching element M1, Cₒₓ indicates a capacitance of the first switching element M1, W/L indicates a ratio of a width and a length of a channel of the first switching element M1, VDD indicates the first power voltage ELVDD, V_{dsat2} indicates a saturation voltage of the second switching element M2, Vₜₕ₂ indicates a threshold voltage of the second switching element M2, C₁ indicates a capacitance of the first capacitor, C₂ indicates a capacitance of the second capacitor, V_{DATA} indicates the data voltage, V_{REF} indicates the reference voltage, Vₜₕ₁ indicates a threshold voltage of the first switching element M1, gₘ indicates a trans-conductance of the first switching element M1 and R_{dio} indicates a resistance of the second switching element M2, the following equation:

$${I}_{d} = \frac{1}{2} {μ}_{p} {C}_{ox} \frac{W}{L} {( \frac{VDD - {V}_{dsat 2} - \vert {V}_{th 2} \vert - \frac{{C}_{1}}{{C}_{1} + {C}_{2}} \cdot ( {V}_{DATA} - {V}_{REF} )}{1 + {g}_{m} {R}_{dio}} - \vert {V}_{th 1} \vert )}^{2}$$

may be satisfied.

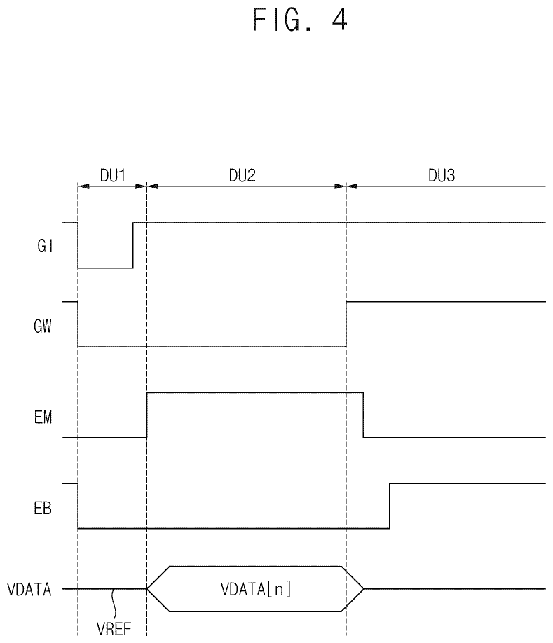

FIG. 4 is a timing diagram illustrating an example of input signals applied to the pixel of FIG. 2.

A timing diagram of FIG. 4 is substantially the same as the timing diagram of FIG. 3 except for the third period DU3.

In an embodiment, as shown in FIG. 4, in a third period DU3 subsequent to the second period DU2, the initialization gate signal GI may have the inactive level and the writing gate signal GW may have an inactive level. The emission signal EM may be changed from the inactive level to the active level at a first time point subsequent to a start point of the third period DU3 and the light emitting element initialization gate signal EB may be changed from the active level to an inactive level at a second time point subsequent to the start point of the third period DU3.

In the third period DU3, the fifth switching element M5, the second switching element M2 and the first switching element M1 may be turned on and the driving current may flow through the fifth switching element M5, the second switching element M2, the first switching element M1 and the light emitting element EE such that the light emitting element EE may emit light.

In such an embodiment, the writing gate signal GW may be changed from the active level to an inactive level at the start point of the third period DU3, the emission signal EM may be changed from the inactive level to the active level at the first time point subsequent to the start point of the third period DU3 and the light emitting element initialization gate signal EB may be changed from the active level to the inactive level at the second time point subsequent to the start point of the third period DU3. In such an embodiment, as described above, time margins are set between the level change of the writing gate signal GW, the level change of the emission signal EM and the level change of the light emitting element initialization gate signal EB such that the reliability and the stability of the light emission operation of the pixel.

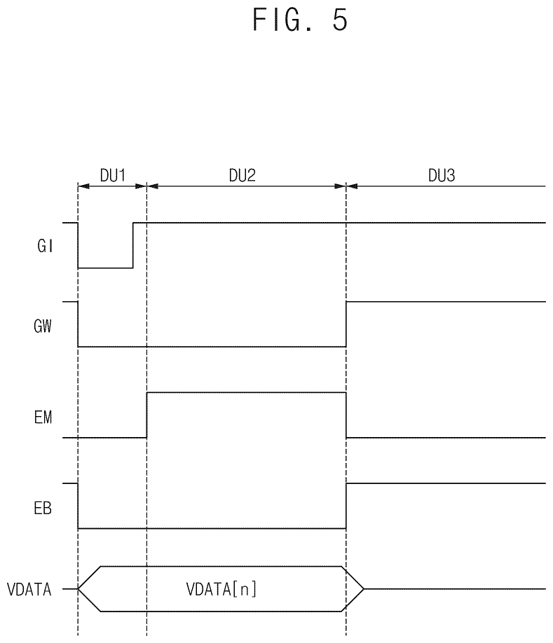

FIG. 5 is a timing diagram illustrating an example of input signals applied to the pixel of FIG. 2.

A timing diagram of FIG. 5 is substantially the same as the timing diagram of FIG. 5 except for the data voltage VDATA in the first period DU1.

In an embodiment, as shown in FIG. 5, in a first period DU1, the initialization gate signal GI may have an active level, the writing gate signal GW may have an active level, the emission signal EM may have an active level, the light emitting element initialization gate signal EB may have an active level and the data voltage VDATA may have a present grayscale data voltage VDATA[n].

In such an embodiment, the data voltage VDATA does not have the reference voltage VREF but the present grayscale data voltage VDATA[n] in the first period DU1. A level of the present grayscale data voltage VDATA[n] may have a level similar to the reference voltage VREF such that the first node N1 may be initialized using the present grayscale data voltage VDATA[n] instead of the reference voltage VREF.

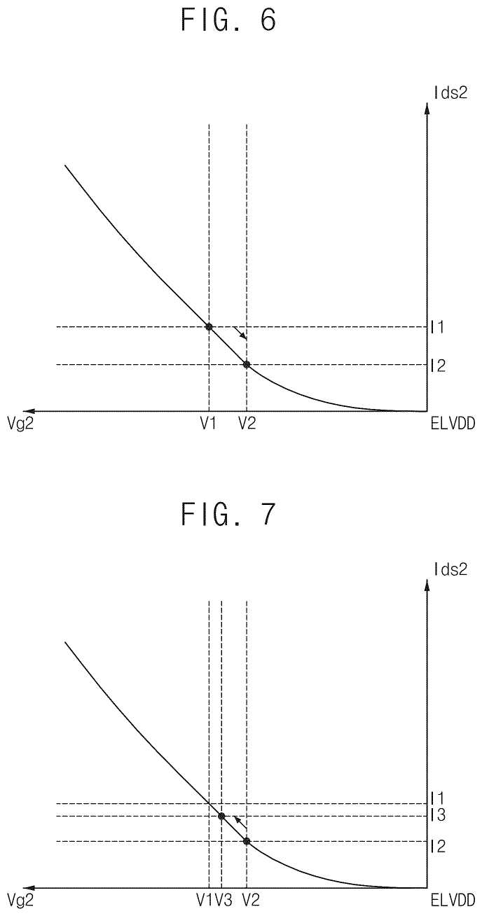

FIGS. 6 to 8 are graphs illustrating a compensation of a threshold voltage of the first switching element M1 and a compensation of a threshold voltage of the light emitting element EE by the second switching element M2 of FIG. 2.

Referring to FIGS. 1 to 8, the second switching element M2 in the diode-connection may operate a source degeneration operation. The source degeneration may mean linearizing a relationship between an output current or an output voltage with respect to an input voltage of an amplifier using a resistance component formed in a source electrode.

The micro organic light emitting diode usually achieves white luminance at a current level of several nanoamperes (nA). Accordingly, in an embodiment, the source degeneration may be implemented by connecting a diode (e.g., the second switching element M2) with a high resistance to the source electrode.

The threshold voltage of the first switching element M1 and the threshold voltage of the light emitting element EE may have variations according to areas in the display panel 100. Thus, pixels may initially have different threshold voltages of the first switching element M1 and different threshold voltages of the light emitting elements EE and an intrinsic frequency of the first switching element M1 may be very fast such that a time for the driving current Ids2 to converge to a compensation point in a manner shown in FIGS. 6 to 8 may be very short. The second switching element M2 having the diode-connection may be formed at the source electrode of the first switching element M1 such that the variation of the threshold voltage of the first switching element M1 may be compensated due to a negative feedback effect on an amount of a change of the threshold voltage of the first switching element M1.

As shown in FIG. 6, when the first switching element M1 in the pixel has a threshold voltage greater than an average threshold voltage while a voltage of a gate electrode (or the control electrode) of the first switching element M1 is applied, the first switching element M1 supplies a current less than an average current to the light emitting element EE. Accordingly, as shown in FIG. 6, an operation point of the second switching element M2 is moved from a first current point I1 to a second current point 12 less than the first current point I1 and therefore, a gate voltage Vg2 of the second switching element M2 may increase from a first voltage V1 to a second voltage V2 greater than the first voltage V1.

As shown in FIG. 7, a source-gate voltage (Vsg1) of the first switching element M1 increases as a result of the operation of FIG. 6 and the driving current of the light emitting element EE increases contrary to FIG. 6. Accordingly, as shown in FIG. 7, an operation point of the second switching element M2 is moved from the second current point 12 to a third current point 13 greater than the second current point 12 and therefore, the gate voltage Vg2 of the second switching element M2 may decrease from the second voltage V2 to a third voltage V3 less than the second voltage V2. However, an amount of a change of the driving current Ids2 and an amount of a change of the gate voltage Vg2 of the second switching element M2 in FIG. 7 are less than the amount of the change of the driving current Ids2 and the amount of the change of the gate voltage Vg2 of the second switching element M2 in FIG. 6.

As shown in FIG. 8, a source-gate voltage (Vsg1) of the first switching element M1 decreases as a result of the operation of FIG. 7 and the driving current of the light emitting element EE increases contrary to FIG. 7. Accordingly, as shown in FIG. 8, an operation point of the second switching element M2 is moved from the third current point 13 to a fourth current point 14 less than the third current point 13 and therefore, the gate voltage Vg2 of the second switching element M2 may increase from the third voltage V3 to a fourth voltage V4 greater than the third voltage V3. However, an amount of a change of the driving current Ids2 and an amount of a change of the gate voltage Vg2 of the second switching element M2 in FIG. 8 are less than the amount of the change of the driving current Ids2 and the amount of the change of the gate voltage Vg2 of the second switching element M2 in FIG. 7.

In this way, the driving current Ids2 and the gate voltage Vg2 of the second switching element M2 may converge to specific values, and accordingly, the threshold voltage of the first switching element M1 and the threshold voltage of the light emitting element EE may be compensated.

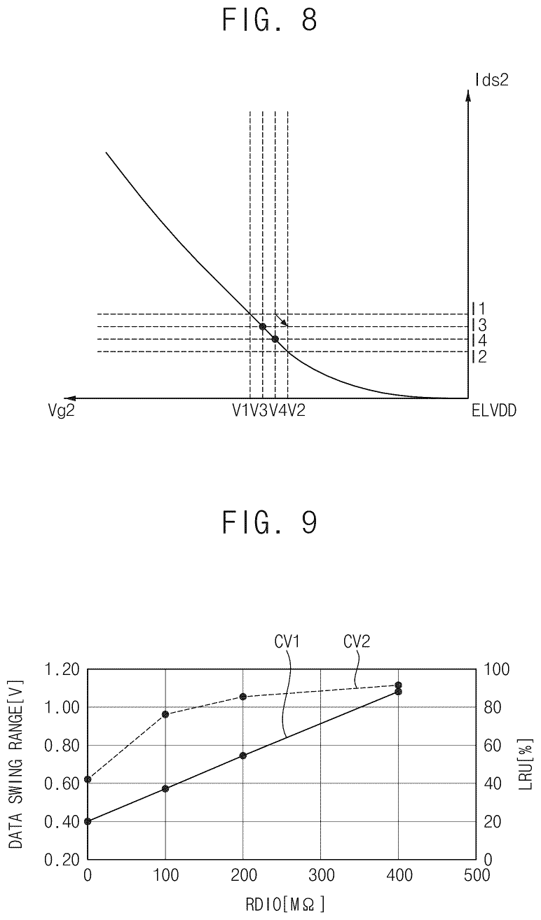

FIG. 9 is a graph illustrating an increase of a data swing range and an enhancement of a uniformity by the second switching element M2 of FIG. 2.

Referring to FIGS. 1 to 9, the second switching element M2 may be modeled as a resistor, the resistor of the second switching element M2 may be represented as RDIO. When the resistor RDIO of the second switching element M2 increases, the data swing range (DSR) is expanded and a long range uniformity (LRU) may be enhanced by the linearization effect in which a part of the data voltage VDATA is applied to the diode-connected second switching element M2. In an embodiment, the data voltage VDATA may be distributed by charge distribution of the first capacitor C1 and the second capacitor C2 such that the data swing range may be further expanded.

In FIG. 9, the data swing range according to the resistor RDIO of the second switching element M2 is represented as CV1 and the long range uniformity according to the resistor RDIO of the second switching element M2 is represented as CV2.

According to an embodiment, the pixel may include the second switching element M2 having a diode-connection, the first capacitor C1 and the second capacitor C2.

In an embodiment, as described above, the pixel may include the second switching element M2 having the diode-connection such that a variation of the threshold voltage of the driving switching element M1 and a variation of the threshold voltage of the light emitting element EE may be compensated.

In such an embodiment, the data swing range, which is wider than the data range of the driving switching element M1, may be obtained due to the linearization effect of the second switching element M2. In such an embodiment, the data voltage VDATA is distributed by charge distribution of the first capacitor C1 and the second capacitor C2 such that the data swing range may be further expanded.

In an embodiment, the first switching element M1 and the sixth switching element M6 are implemented as high-voltage MOSFETs and the second switching element M2, the third switching element M3, the fourth switching element M4 and the fifth switching element M5 are implemented as medium-voltage MOSFETs such that an area of the pixel may be decreased and accordingly, a resolution of the display panel 100 may be increased.

In such an embodiment, the second switching element M2 is implemented as a medium-voltage MOSFET such that a voltage margin may be further obtained by a threshold voltage of the second switching element M2.

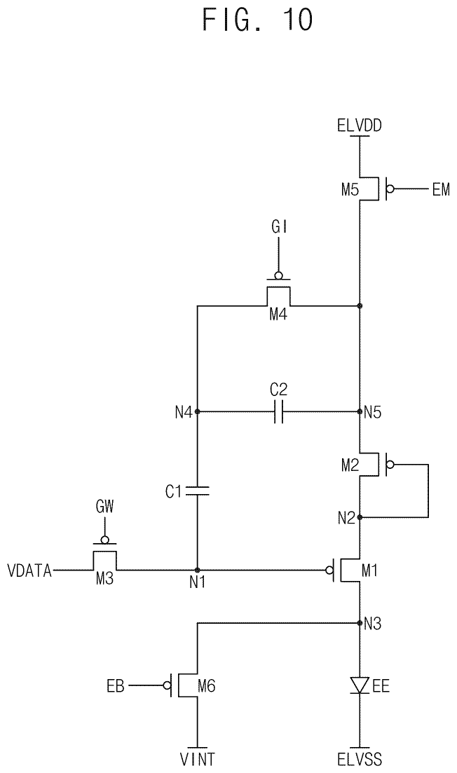

FIG. 10 is a circuit diagram illustrating a pixel of a display panel of a display apparatus according to an embodiment of the invention.

The embodiment of the display including the pixel shown in FIG. 10 is substantially the same as the embodiments of the display apparatus described above referring to FIGS. 1 to 9 except for the fourth switching element of the pixel. Thus, the same reference numerals will be used to refer to the same or like parts as those described above referring to FIGS. 1 to 9 and any repetitive detailed description thereof will be omitted or simplified.

Referring to FIGS. 1 and 3 to 10, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 10, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In such an embodiment, the second capacitor C2 may include a first electrode connected to the fourth node N4 and a second electrode connected to the fifth node N5.

The fourth switching element M4 receives the initialization gate signal GI and connected to the fourth node N4. In such an embodiment, the fourth switching element M4 may include a control electrode that receives the initialization gate signal GI, a first electrode connected to the fifth node N5 and a second electrode connected to the fourth node N4.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

In such an embodiment, the first switching element M1 and the sixth switching element M6 are implemented as high-voltage MOSFETs and the second switching element M2, the third switching element M3, the fourth switching element M4 and the fifth switching element M5 are implemented as medium-voltage MOSFETs such that an area of the pixel may be decreased and accordingly, a resolution of the display panel 100 may be increased.

In addition, the second switching element M2 is implemented as a medium-voltage MOSFET such that a voltage margin may be further obtained by a threshold voltage of the second switching element M2.

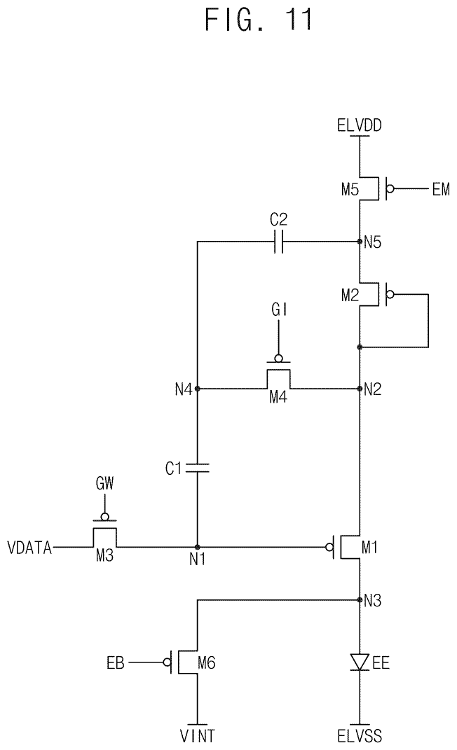

FIG. 11 is a circuit diagram illustrating a pixel of a display panel of a display apparatus according to an embodiment of the invention.

The embodiment of the display including the pixel shown in FIG. 11 is substantially the same as the embodiments of the display apparatus described above referring to FIGS. 1 to 9 except for the fourth switching element of the pixel. Thus, the same reference numerals will be used to refer to the same or like parts as those described above referring to FIGS. 1 to 9 and any repetitive detailed description thereof will be omitted or simplified.

Referring to FIGS. 1, 3 to 9 and 11, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 11, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In such an embodiment, the second capacitor C2 may include a first electrode connected to the fourth node N4 and a second electrode connected to the fifth node N5.

The fourth switching element M4 receives the initialization gate signal GI and connected to the fourth node N4. In such an embodiment, the fourth switching element M4 may include a control electrode that receives the initialization gate signal GI, a first electrode connected to the second node N2 and a second electrode connected to the fourth node N4.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

In such an embodiment, the first switching element M1 and the sixth switching element M6 are implemented as high-voltage MOSFETs and the second switching element M2, the third switching element M3, the fourth switching element M4 and the fifth switching element M5 are implemented as medium-voltage MOSFETs such that an area of the pixel may be decreased and accordingly, a resolution of the display panel 100 may be increased.

In addition, the second switching element M2 is implemented as a medium-voltage MOSFET such that a voltage margin may be further obtained by a threshold voltage of the second switching element M2.

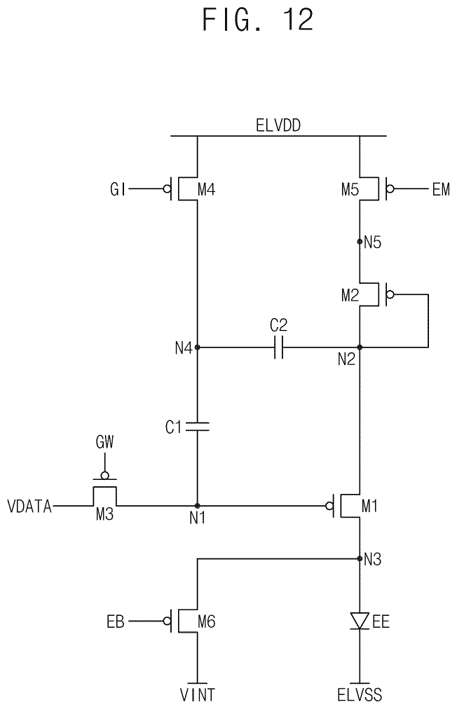

FIG. 12 is a circuit diagram illustrating a pixel of a display panel of a display apparatus according to an embodiment of the invention.

The embodiment of the display including the pixel shown in FIG. 12 is substantially the same as the embodiments of the display apparatus described above referring to FIGS. 1 to 9 except for the second capacitor of the pixel. Thus, the same reference numerals will be used to refer to the same or like parts as those described above referring to FIGS. 1 to 9 and any repetitive detailed description thereof will be omitted or simplified.

Referring to FIGS. 1, 3 to 9 and 12, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 12, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In such an embodiment, the second capacitor C2 may include a first electrode connected to the fourth node N4 and a second electrode connected to the second node N2.

The fourth switching element M4 receives the initialization gate signal GI and connected to the fourth node N4. In such an embodiment, the fourth switching element M4 may include a control electrode that receives the initialization gate signal GI, a first electrode that receives the first power voltage ELVDD and a second electrode connected to the fourth node N4.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

In such an embodiment, the first switching element M1 and the sixth switching element M6 are implemented as high-voltage MOSFETs and the second switching element M2, the third switching element M3, the fourth switching element M4 and the fifth switching element M5 are implemented as medium-voltage MOSFETs such that an area of the pixel may be decreased and accordingly, a resolution of the display panel 100 may be increased.

In addition, the second switching element M2 is implemented as a medium-voltage MOSFET such that a voltage margin may be further obtained by a threshold voltage of the second switching element M2.

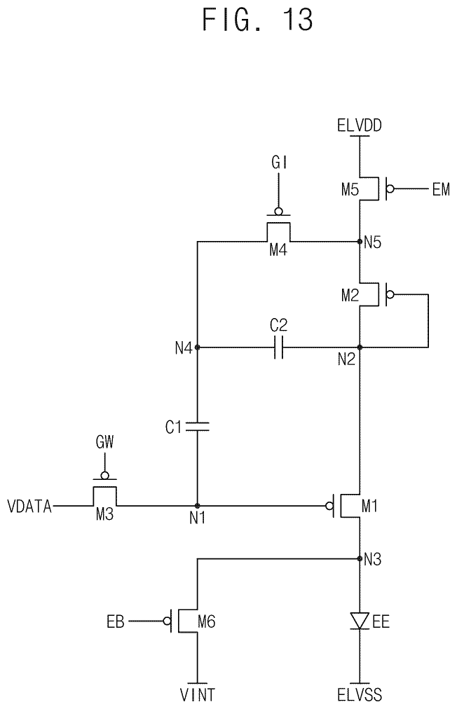

FIG. 13 is a circuit diagram illustrating a pixel of a display panel of a display apparatus according to an embodiment of the invention.

The embodiment of the display including the pixel shown in FIG. 13 is substantially the same as the embodiments of the display apparatus described above referring to FIGS. 1 to 9 except for the second capacitor and the fourth switching element of the pixel. Thus, the same reference numerals will be used to refer to the same or like parts as those described above referring to FIGS. 1 to 9 and any repetitive detailed description thereof will be omitted or simplified.

Referring to FIGS. 1, 3 to 9 and 13, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 13, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In the embodiment, the second capacitor C2 may include a first electrode connected to the fourth node N4 and a second electrode connected to the second node N2.

The fourth switching element M4 receives the initialization gate signal GI and connected to the fourth node N4. In the embodiment, the fourth switching element M4 may include a control electrode that receives the initialization gate signal GI, a first electrode connected to the fifth node N5 and a second electrode connected to the fourth node N4.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

In such an embodiment, the first switching element M1 and the sixth switching element M6 are implemented as high-voltage MOSFETs and the second switching element M2, the third switching element M3, the fourth switching element M4 and the fifth switching element M5 are implemented as medium-voltage MOSFETs such that an area of the pixel may be decreased and accordingly, a resolution of the display panel 100 may be increased.

In addition, the second switching element M2 is implemented as a medium-voltage MOSFET such that a voltage margin may be further obtained by a threshold voltage of the second switching element M2.

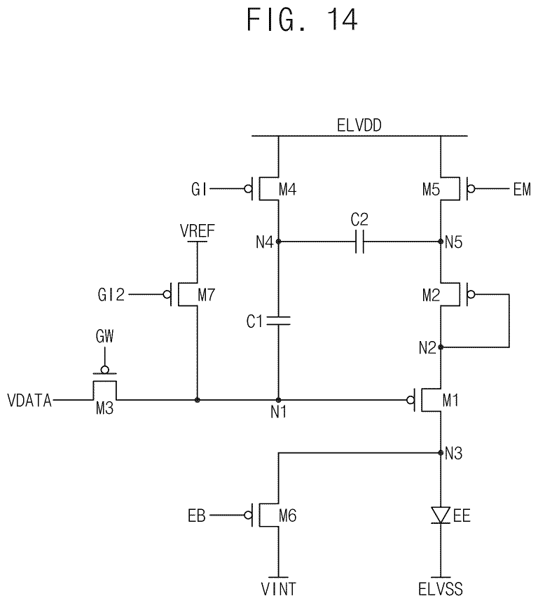

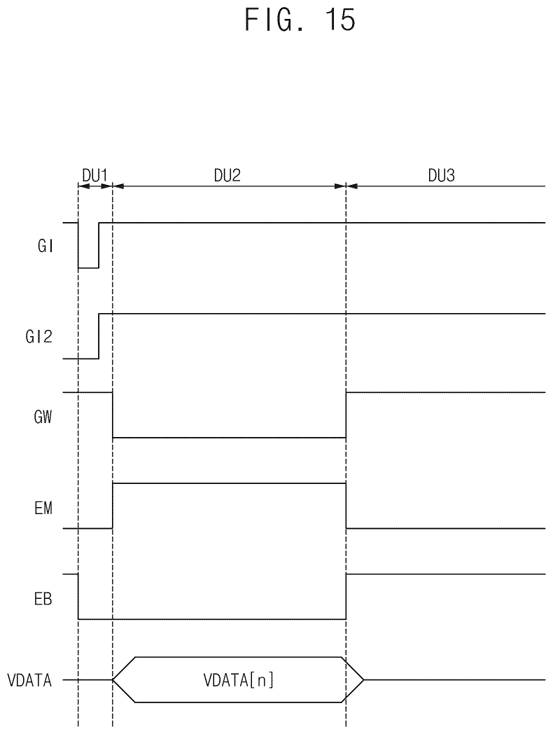

FIG. 14 is a circuit diagram illustrating a pixel of a display panel of a display apparatus according to an embodiment of the invention. FIG. 15 is a timing diagram illustrating an example of input signals applied to the pixel of FIG. 14.

The embodiment of the display including the pixel shown in FIG. 14 is substantially the same as the embodiments of the display apparatus described above referring to FIGS. 1 to 9 except that the pixel further includes a seventh switching element. Thus, the same reference numerals will be used to refer to the same or like parts as those described above referring to FIGS. 1 to 9 and any repetitive detailed description thereof will be omitted or simplified.

Referring to FIGS. 1, 4 to 9, 14 and 15, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 14, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In such an embodiment, the second capacitor C2 may include a first electrode connected to the fourth node N4 and a second electrode connected to the fifth node N5.

The fourth switching element M4 receives the initialization gate signal GI and connected to the fourth node N4. In such an embodiment, the fourth switching element M4 may include a control electrode that receives the initialization gate signal GI, a first electrode that receives a first power voltage ELVDD and a second electrode connected to the fourth node N4.

In such an embodiment, as shown in FIG. 14, the pixel may further include a seventh switching element M7 including a control electrode that receives a second initialization gate signal GI2, a first electrode that receives a reference voltage VREF and a second electrode connected to the first node N1.

As shown in FIG. 15, in a first period DU1, the initialization gate signal GI may have an active level, the second initialization gate signal GI2 may have an active level, the writing gate signal GW may have an active level, the emission signal EM may have an active level, the light emitting element initialization gate signal EB may have an active level and the data voltage VDATA may have a reference voltage VREF.

In a second period DU2 subsequent to the first period DU1, the initialization gate signal GI may have an inactive level, the second initialization gate signal GI2 may have an inactive level, the writing gate signal GW may have the active level, the emission signal EM may have an inactive level, the light emitting element initialization gate signal EB may have the active level and the data voltage VDATA may have a present grayscale data voltage VDATA[n].

In a third period DU3 subsequent to the second period DU2, the initialization gate signal GI may have the inactive level, the second initialization gate signal GI2 may have the inactive level, the writing gate signal GW may have an inactive level, the emission signal EM may have the active level and the light emitting element initialization gate signal EB may have an inactive level.

In such an embodiment, the first node N1 may be initialized using the seventh switching element M7 such that a duration of the first period DU1 may be reduced and a duration of the second period DU2 may be increased compared to the embodiment of FIG. 3. In such an embodiment, a ratio of the duration of the data writing period DU2 may be relatively increased such that the display panel 100 may support an ultra high resolution and an ultra high speed operation.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

In such an embodiment, the first switching element M1 and the sixth switching element M6 are implemented as high-voltage MOSFETs and the second switching element M2, the third switching element M3, the fourth switching element M4 and the fifth switching element M5 are implemented as medium-voltage MOSFETs such that an area of the pixel may be decreased and accordingly, a resolution of the display panel 100 may be increased.

In addition, the second switching element M2 is implemented as a medium-voltage MOSFET such that a voltage margin may be further obtained by a threshold voltage of the second switching element M2.

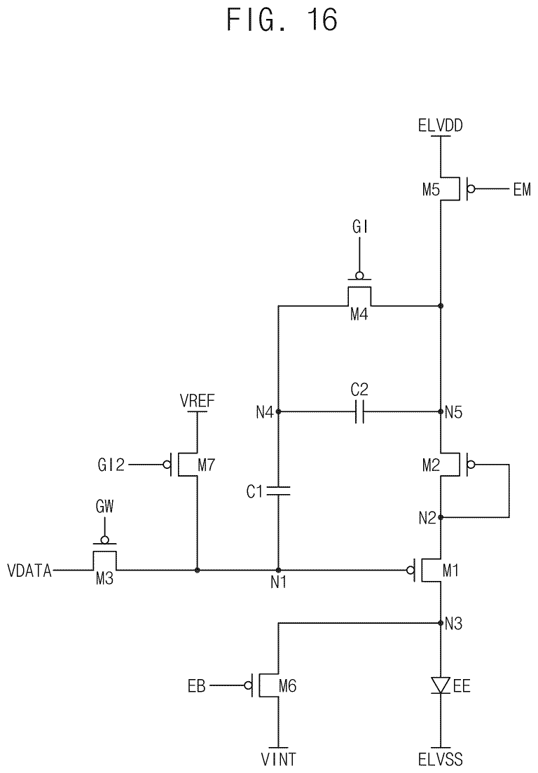

FIG. 16 is a circuit diagram illustrating a pixel of a display panel of a display apparatus according to an embodiment of the invention.

The embodiment of the display including the pixel shown in FIG. 16 is substantially the same as the embodiments of the display apparatus described above referring to FIG. 10 except that the pixel further includes a seventh switching element. Thus, the same reference numerals will be used to refer to the same or like parts as those described above referring to FIG. 10 and any repetitive detailed description thereof will be omitted or simplified.

Referring to FIGS. 1, 4 to 9, 15 and 16, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 16, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In such an embodiment, the second capacitor C2 may include a first electrode connected to the fourth node N4 and a second electrode connected to the fifth node N5.

The fourth switching element M4 receives the initialization gate signal GI and connected to the fourth node N4. In such an embodiment, the fourth switching element M4 may include a control electrode that receives the initialization gate signal GI, a first electrode connected to the fifth node N5 and a second electrode connected to the fourth node N4.

In such an embodiment, as shown in FIG. 16, the pixel may further include a seventh switching element M7 including a control electrode that receives a second initialization gate signal GI2, a first electrode that receives a reference voltage VREF and a second electrode connected to the first node N1.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

In such an embodiment, the first switching element M1 and the sixth switching element M6 are implemented as high-voltage MOSFETs and the second switching element M2, the third switching element M3, the fourth switching element M4 and the fifth switching element M5 are implemented as medium-voltage MOSFETs such that an area of the pixel may be decreased and accordingly, a resolution of the display panel 100 may be increased.

In addition, the second switching element M2 is implemented as a medium-voltage MOSFET such that a voltage margin may be further obtained by a threshold voltage of the second switching element M2.

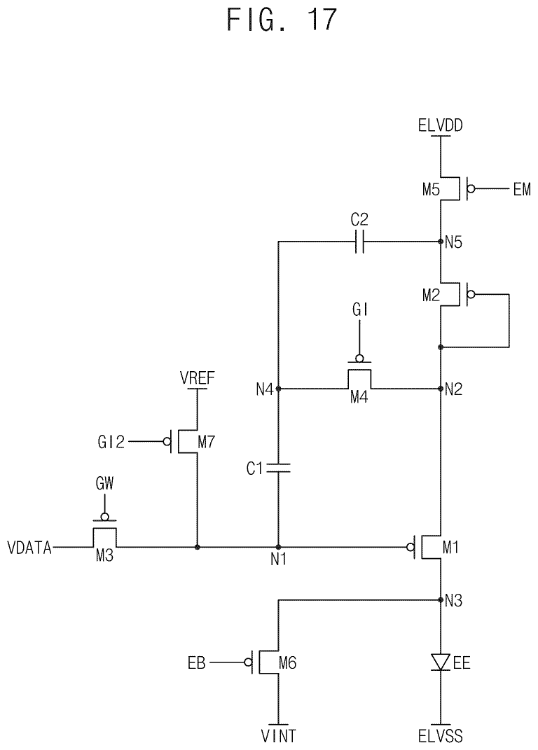

FIG. 17 is a circuit diagram illustrating a pixel of a display panel of a display apparatus according to an embodiment of the invention.

The embodiment of the display including the pixel shown in FIG. 16 is substantially the same as the embodiments of the display apparatus described above referring to FIG. 11 except that the pixel further includes a seventh switching element. Thus, the same reference numerals will be used to refer to the same or like parts as those described above referring to FIG. 11 and any repetitive detailed description thereof will be omitted or simplified.

Referring to FIGS. 1, 4 to 9, 15 and 17, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 17, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In such an embodiment, the second capacitor C2 may include a first electrode connected to the fourth node N4 and a second electrode connected to the fifth node N5.

The fourth switching element M4 receives the initialization gate signal GI and connected to the fourth node N4. In such an embodiment, the fourth switching element M4 may include a control electrode that receives the initialization gate signal GI, a first electrode connected to the second node N2 and a second electrode connected to the fourth node N4.

In such an embodiment, as shown in FIG. 17, the pixel may further include a seventh switching element M7 including a control electrode that receives a second initialization gate signal GI2, a first electrode that receives a reference voltage VREF and a second electrode connected to the first node N1.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

In such an embodiment, the first switching element M1 and the sixth switching element M6 are implemented as high-voltage MOSFETs and the second switching element M2, the third switching element M3, the fourth switching element M4 and the fifth switching element M5 are implemented as medium-voltage MOSFETs such that an area of the pixel may be decreased and accordingly, a resolution of the display panel 100 may be increased.

In addition, the second switching element M2 is implemented as a medium-voltage MOSFET such that a voltage margin may be further obtained by a threshold voltage of the second switching element M2.

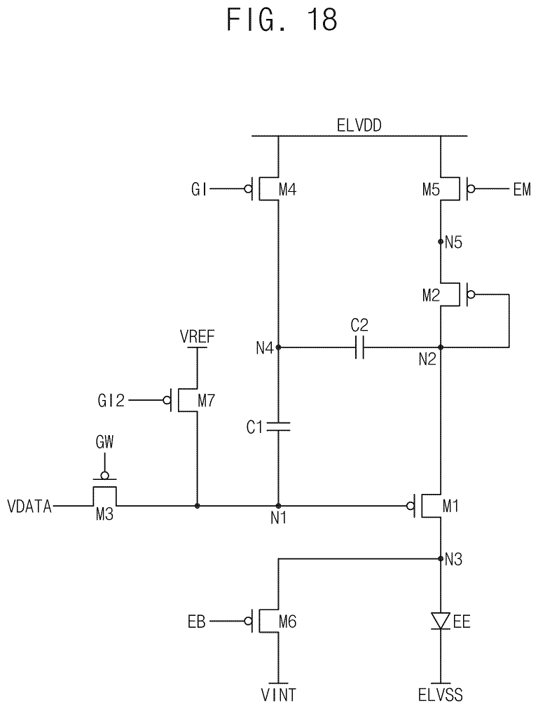

FIG. 18 is a circuit diagram illustrating a pixel of a display panel of a display apparatus according to an embodiment of the invention.

The embodiment of the display including the pixel shown in FIG. 18 is substantially the same as the embodiments of the display apparatus described above referring to FIG. 12 except that the pixel further includes a seventh switching element. Thus, the same reference numerals will be used to refer to the same or like parts as those described above referring to FIG. 12 and any repetitive detailed description thereof will be omitted or simplified.

Referring to FIGS. 1, 4 to 9, 15 and 18, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 18, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In the embodiment, the second capacitor C2 may include a first electrode connected to the fourth node N4 and a second electrode connected to the second node N2.

The fourth switching element M4 receives the initialization gate signal GI and connected to the fourth node N4. In the embodiment, the fourth switching element M4 may include a control electrode that receives the initialization gate signal GI, a first electrode that receives the first power voltage ELVDD and a second electrode connected to the fourth node N4.

In such an embodiment, as shown in FIG. 18, the pixel may further include a seventh switching element M7 including a control electrode that receives a second initialization gate signal GI2, a first electrode that receives a reference voltage VREF and a second electrode connected to the first node N1.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

In such an embodiment, the first switching element M1 and the sixth switching element M6 are implemented as high-voltage MOSFETs and the second switching element M2, the third switching element M3, the fourth switching element M4 and the fifth switching element M5 are implemented as medium-voltage MOSFETs such that an area of the pixel may be decreased and accordingly, a resolution of the display panel 100 may be increased.

In addition, the second switching element M2 is implemented as a medium-voltage MOSFET such that a voltage margin may be further obtained by a threshold voltage of the second switching element M2.

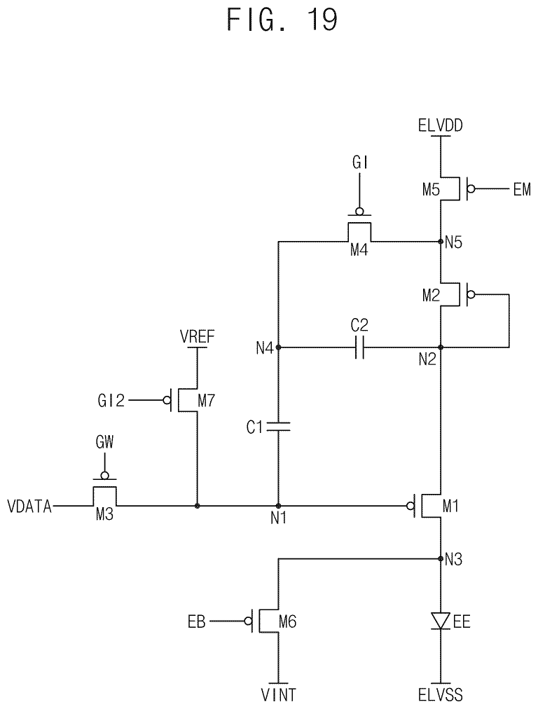

FIG. 19 is a circuit diagram illustrating a pixel of a display panel of a display apparatus according to an embodiment of the invention.

The embodiment of the display including the pixel shown in FIG. 19 is substantially the same as the embodiments of the display apparatus described above referring to FIG. 13 except that the pixel further includes a seventh switching element. Thus, the same reference numerals will be used to refer to the same or like parts as those described above referring to FIG. 13 and any repetitive detailed description thereof will be omitted or simplified.

Referring to FIGS. 1, 4 to 9, 15 and 19, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 19, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In the embodiment, the second capacitor C2 may include a first electrode connected to the fourth node N4 and a second electrode connected to the second node N2.

The fourth switching element M4 receives the initialization gate signal GI and connected to the fourth node N4. In the embodiment, the fourth switching element M4 may include a control electrode that receives the initialization gate signal GI, a first electrode connected to the fifth node N5 and a second electrode connected to the fourth node N4.

In such an embodiment, as shown in FIG. 19, the pixel may further include a seventh switching element M7 including a control electrode that receives a second initialization gate signal GI2, a first electrode that receives a reference voltage VREF and a second electrode connected to the first node N1.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

In such an embodiment, the first switching element M1 and the sixth switching element M6 are implemented as high-voltage MOSFETs and the second switching element M2, the third switching element M3, the fourth switching element M4 and the fifth switching element M5 are implemented as medium-voltage MOSFETs such that an area of the pixel may be decreased and accordingly, a resolution of the display panel 100 may be increased.

In addition, the second switching element M2 is implemented as a medium-voltage MOSFET such that a voltage margin may be further obtained by a threshold voltage of the second switching element M2.

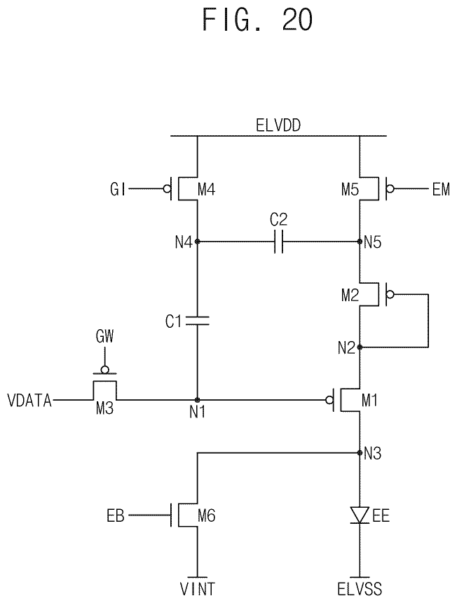

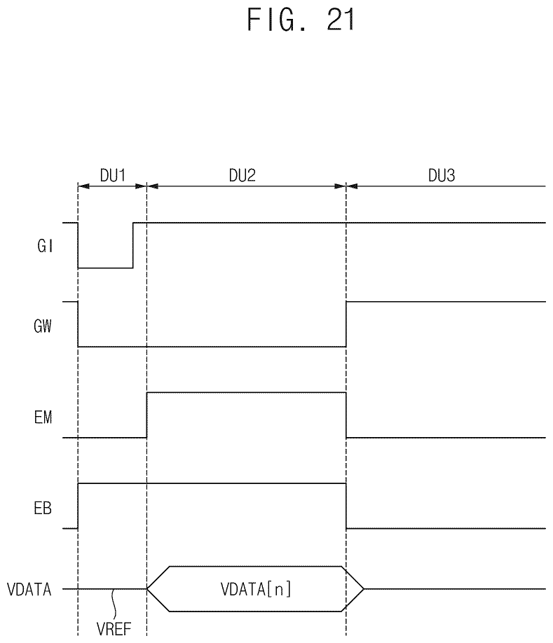

FIG. 20 is a circuit diagram illustrating a pixel of a display panel of a display apparatus according to an embodiment of the invention. FIG. 21 is a timing diagram illustrating an example of input signals applied to the pixel of FIG. 20.

The embodiment of the display including the pixel shown in FIG. 20 is substantially the same as the embodiments of the display apparatus described above referring to FIGS. 1 to 9 except that the sixth switching element of the pixel is an N-type transistor. Thus, the same reference numerals will be used to refer to the same or like parts as those described above referring to FIGS. 1 to 9 and any repetitive detailed description thereof will be omitted or simplified.

Referring to FIGS. 1, 4 to 9, 20 and 21, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 20, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In such an embodiment, the second capacitor C2 may include a first electrode connected to the fourth node N4 and a second electrode connected to the fifth node N5.

The fourth switching element M4 receives the initialization gate signal GI and connected to the fourth node N4. In such an embodiment, the fourth switching element M4 may include a control electrode that receives the initialization gate signal GI, a first electrode that receives the first power voltage ELVDD and a second electrode connected to the fourth node N4.

In such an embodiment, the first switching element M1, the second switching element M2, the third switching element M3, the fourth switching element M4 and the fifth switching element M5 may be P-type transistors. In an embodiment, for example, the first switching element M1, the second switching element M2, the third switching element M3, the fourth switching element M4 and the fifth switching element M5 may be low temperature polysilicon (LTPS) thin film transistors.

In such an embodiment, the sixth switching element M6 may be an N-type transistor. In an embodiment, for example, the sixth switching element M6 may be an oxide semiconductor thin film transistor.

The timing diagram of FIG. 21 is substantially the same as the timing diagram of FIG. 3 except that the light emitting element initialization gate signal EB is inverted.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

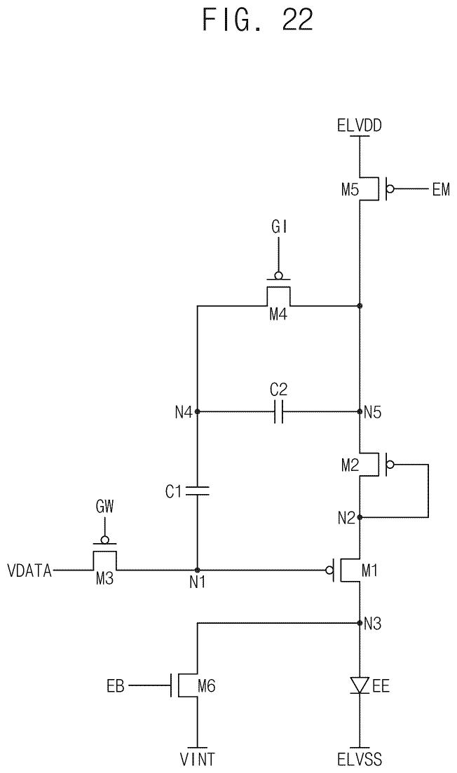

FIG. 22 is a circuit diagram illustrating a pixel of a display panel of a display apparatus according to an embodiment of the invention.

The embodiment of the display including the pixel shown in FIG. 22 is substantially the same as the embodiments of the display apparatus described above referring to FIG. 10 except that the sixth switching element of the pixel is an N-type transistor. Thus, the same reference numerals will be used to refer to the same or like parts as those described above referring to FIG. 10 and any repetitive detailed description thereof will be omitted or simplified.

Referring to FIGS. 1, 4 to 9, 21 and 22, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In such an embodiment, the first switching element M1, the second switching element M2, the third switching element M3, the fourth switching element M4 and the fifth switching element M5 may be P-type transistors. In an embodiment, for example, the first switching element M1, the second switching element M2, the third switching element M3, the fourth switching element M4 and the fifth switching element M5 may be low temperature polysilicon (LTPS) thin film transistors.

In such an embodiment, the sixth switching element M6 may be an N-type transistor. In an embodiment, for example, the sixth switching element M6 may be an oxide semiconductor thin film transistor.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

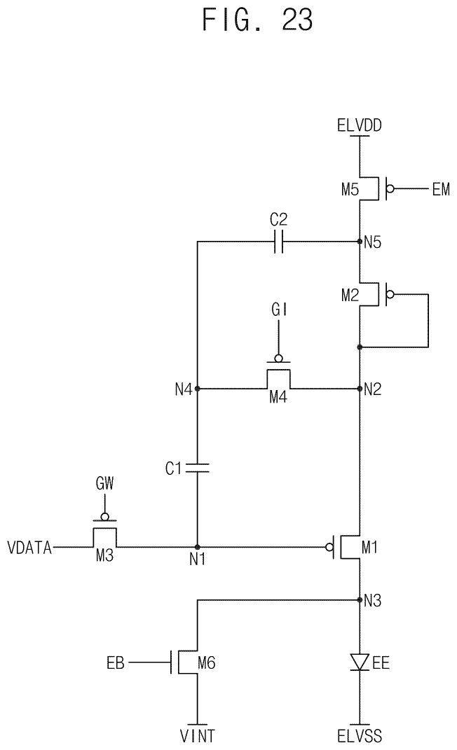

FIG. 23 is a circuit diagram illustrating a pixel of a display panel of a display apparatus according to an embodiment of the invention.

The embodiment of the display including the pixel shown in FIG. 23 is substantially the same as the embodiments of the display apparatus described above referring to FIG. 11 except that the sixth switching element of the pixel is an N-type transistor. Thus, the same reference numerals will be used to refer to the same or like parts as those described above referring to FIG. 11 and any repetitive detailed description thereof will be omitted or simplified.

Referring to FIGS. 1, 4 to 9, 21 and 23, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In such an embodiment, the first switching element M1, the second switching element M2, the third switching element M3, the In an embodiment, for switching element M4 and the fifth switching element M5 may be P-type transistors. In an embodiment, for example, the first switching element M1, the second switching element M2, the third switching element M3, the fourth switching element M4 and the fifth switching element M5 may be low temperature polysilicon (LTPS) thin film transistors.

In such an embodiment, the sixth switching element M6 may be an N-type transistor. In an embodiment, for example, the sixth switching element M6 may be an oxide semiconductor thin film transistor.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

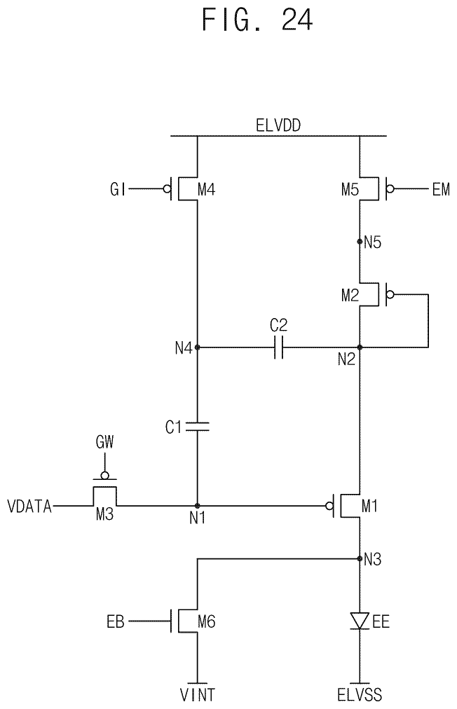

FIG. 24 is a circuit diagram illustrating a pixel of a display panel of a display apparatus according to an embodiment of the invention.

The embodiment of the display including the pixel shown in FIG. 24 is substantially the same as the embodiments of the display apparatus described above referring to FIG. 12 except that the sixth switching element of the pixel is an N-type transistor. Thus, the same reference numerals will be used to refer to the same or like parts as those described above referring to FIG. 12 and any repetitive detailed description thereof will be omitted or simplified.

Referring to FIGS. 1, 4 to 9, 21 and 24, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In such an embodiment, the first switching element M1, the second switching element M2, the third switching element M3, the fourth switching element M4 and the fifth switching element M5 may be P-type transistors. In an embodiment, for example, the first switching element M1, the second switching element M2, the third switching element M3, the fourth switching element M4 and the fifth switching element M5 may be low temperature polysilicon (LTPS) thin film transistors.

In such an embodiment, the sixth switching element M6 may be an N-type transistor. In an embodiment, for example, the sixth switching element M6 may be an oxide semiconductor thin film transistor.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

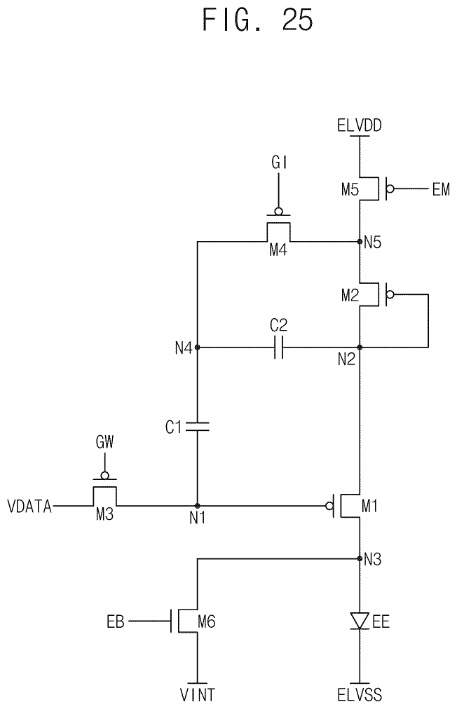

FIG. 25 is a circuit diagram illustrating a pixel of a display panel of a display apparatus according to an embodiment of the invention.

The embodiment of the display including the pixel shown in FIG. 25 is substantially the same as the embodiments of the display apparatus described above referring to FIG. 13 except that the sixth switching element of the pixel is an N-type transistor. Thus, the same reference numerals will be used to refer to the same or like parts as those described above referring to FIG. 13 and any repetitive detailed description thereof will be omitted or simplified.

Referring to FIGS. 1, 4 to 9, 21 and 25, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In such an embodiment, the first switching element M1, the second switching element M2, the third switching element M3, the fourth switching element M4 and the fifth switching element M5 may be P-type transistors. In an embodiment, for example, the first fourth switching element M4 and the fifth switching element M5 may be low temperature polysilicon (LTPS) thin film transistors.

In such an embodiment, the sixth switching element M6 may be an N-type transistor. In an embodiment, for example, the sixth switching element M6 may be an oxide semiconductor thin film transistor.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

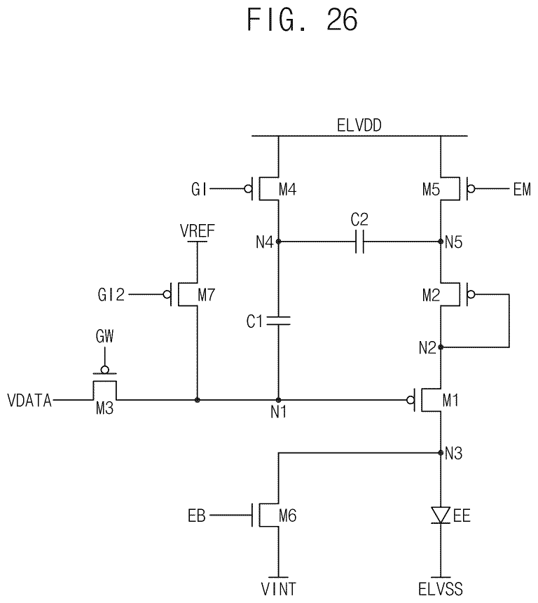

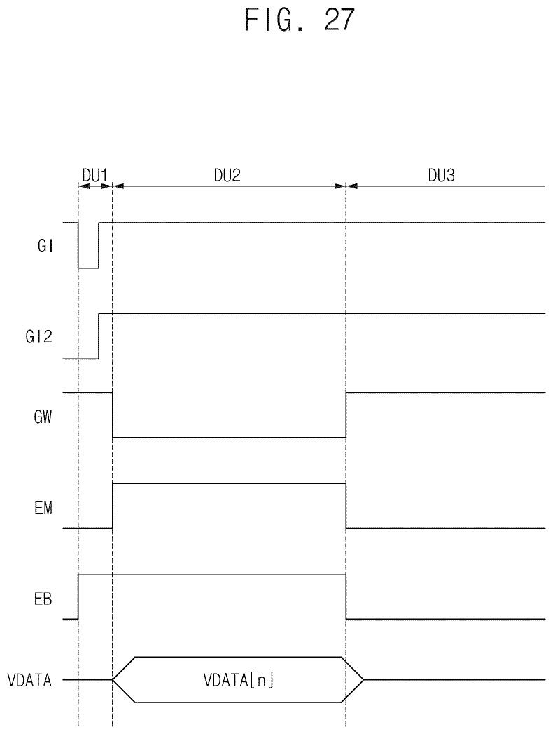

FIG. 26 is a circuit diagram illustrating a pixel of a display panel of a display apparatus according to an embodiment of the invention. FIG. 27 is a timing diagram illustrating an example of input signals applied to the pixel of FIG. 26.

The embodiment of the display including the pixel shown in FIG. 26 is substantially the same as the embodiments of the display apparatus described above referring to FIGS. 14 and 15 except that the sixth switching element of the pixel is an N-type transistor. Thus, the same reference numerals will be used to refer to the same or like parts as those described above referring to FIGS. 14 and 15 and any repetitive detailed description thereof will be omitted or simplified.

Referring to FIGS. 1, 4 to 9, 26 and 27, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In an embodiment, as shown in FIG. 26, the pixel includes a first switching element M1, a second switching element M2, a third switching element M3, a first capacitor C1, a second capacitor C2, a fourth switching element M4 and the light emitting element EE.

The first capacitor C1 includes a first electrode connected to the first node N1 and a second electrode connected to a fourth node N4. The second capacitor C2 is connected to the fourth node N4. In such an embodiment, the second capacitor C2 may include a first electrode connected to the fourth node N4 and a second electrode connected to the fifth node N5.

The fourth switching element M4 receives the initialization gate signal GI and connected to the fourth node N4. In such an embodiment, the fourth switching element M4 may include a control electrode that receives the initialization gate signal GI, a first electrode that receives a first power voltage ELVDD and a second electrode connected to the fourth node N4.

In such an embodiment, the first switching element M1, the second switching element M2, the third switching element M3, the fourth switching element M4 and the fifth switching element M5 may be P-type transistors. In an embodiment, for example, the first switching element M1, the second switching element M2, the third switching element M3, the fourth switching element M4 and the fifth switching element M5 may be low temperature polysilicon (LTPS) thin film transistors.

In such an embodiment, the sixth switching element M6 may be an N-type transistor. In an embodiment, for example, the sixth switching element M6 may be an oxide semiconductor thin film transistor.

In such an embodiment, the pixel may further include a seventh switching element M7 including a control electrode that receives a second initialization gate signal GI2, a first electrode that receives a reference voltage VREF and a second electrode connected to the first node N1. In an embodiment, for example, the seventh switching element M7 may be a P-type transistor.

The timing diagram of FIG. 27 is substantially the same as the timing diagram of FIG. 15 except that the light emitting element initialization gate signal EB is inverted.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

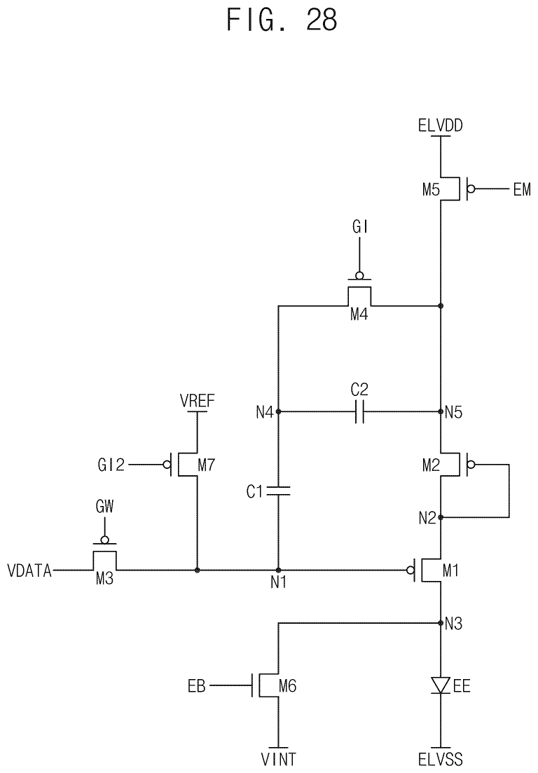

FIG. 28 is a circuit diagram illustrating a pixel of a display panel of a display apparatus according to an embodiment of the invention.

The embodiment of the display including the pixel shown in FIG. 28 is substantially the same as the embodiments of the display apparatus described above referring to FIG. 16 except that the sixth switching element of the pixel is an N-type transistor. Thus, the same reference numerals will be used to refer to the same or like parts as those described above referring to FIG. 16 and any repetitive detailed description thereof will be omitted or simplified.

Referring to FIGS. 1, 4 to 9, 27 and 28, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In such an embodiment, the first switching element M1, the second switching element M2, the third switching element M3, the fourth switching element M4 and the fifth switching element M5 may be P-type transistors. In an embodiment, for example, the first switching element M1, the second switching element M2, the third switching element M3, the fourth switching element M4 and the fifth switching element M5 may be low temperature polysilicon (LTPS) thin film transistors.

In such an embodiment, the sixth switching element M6 may be an N-type transistor. In an embodiment, for example, the sixth switching element M6 may be an oxide semiconductor thin film transistor.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

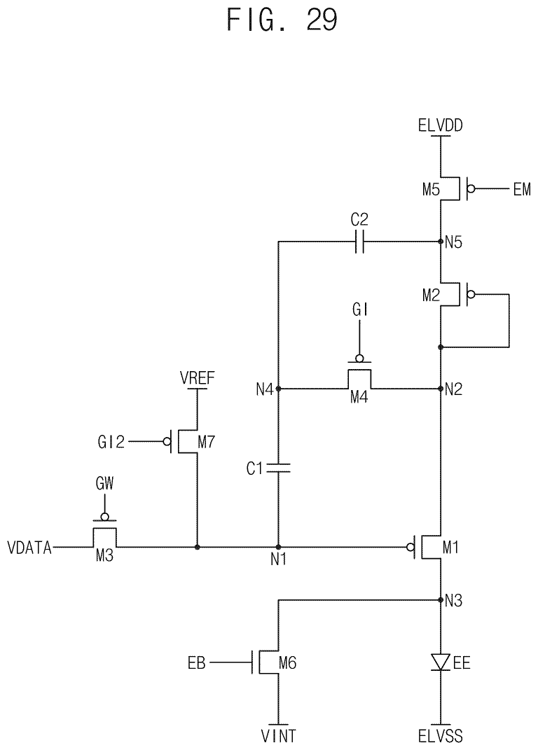

FIG. 29 is a circuit diagram illustrating a pixel of a display panel of a display apparatus according to an embodiment of the invention.

The embodiment of the display including the pixel shown in FIG. 29 is substantially the same as the embodiments of the display apparatus described above referring to FIG. 17 except that the sixth switching element of the pixel is an N-type transistor. Thus, the same reference numerals will be used to refer to the same or like parts as those described above referring to FIG. 17 and any repetitive detailed description thereof will be omitted or simplified.

Referring to FIGS. 1, 4 to 9, 27 and 29, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In such an embodiment, the first switching element M1, the second switching element M2, the third switching element M3, the fourth switching element M4 and the fifth switching element M5 may be P-type transistors. In an embodiment, for example, the first switching element M1, the second switching element M2, the third switching element M3, the fourth switching element M4 and the fifth switching element M5 may be low temperature polysilicon (LTPS) thin film transistors.

In such an embodiment, the sixth switching element M6 may be an N-type transistor. In an embodiment, for example, the sixth switching element M6 may be an oxide semiconductor thin film transistor.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

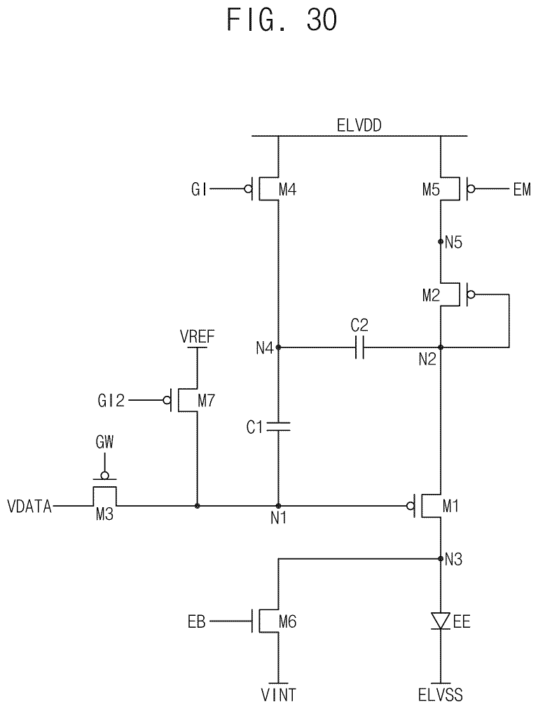

FIG. 30 is a circuit diagram illustrating a pixel of a display panel of a display apparatus according to an embodiment of the invention.

The embodiment of the display including the pixel shown in FIG. 30 is substantially the same as the embodiments of the display apparatus described above referring to FIG. 18 except that the sixth switching element of the pixel is an N-type transistor. Thus, the same reference numerals will be used to refer to the same or like parts as those described above referring to FIG. 18 and any repetitive detailed description thereof will be omitted or simplified.

Referring to FIGS. 1, 4 to 9, 27 and 30, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In such an embodiment, the first switching element M1, the second switching element M2, the third switching element M3, the fourth switching element M4 and the fifth switching element M5 may be P-type transistors. In an embodiment, for example, the first switching element M1, the second switching element M2, the third switching element M3, the fourth switching element M4 and the fifth switching element M5 may be low temperature polysilicon (LTPS) thin film transistors.

In such an embodiment, the sixth switching element M6 may be an N-type transistor. In an embodiment, for example, the sixth switching element M6 may be an oxide semiconductor thin film transistor.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

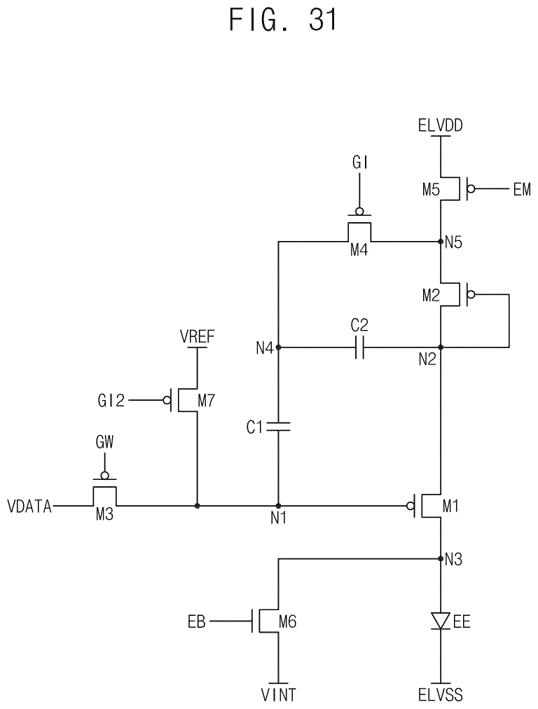

FIG. 31 is a circuit diagram illustrating a pixel of a display panel of a display apparatus according to an embodiment of the invention.

The embodiment of the display including the pixel shown in FIG. 31 is substantially the same as the embodiments of the display apparatus described above referring to FIG. 19 except that the sixth switching element of the pixel is an N-type transistor. Thus, the same reference numerals will be used to refer to the same or like parts as those described above referring to FIG. 19 and any repetitive detailed description thereof will be omitted or simplified.

Referring to FIGS. 1, 4 to 9, 27 and 31, an embodiment of the display panel 100 includes the plurality of the pixels. Each pixel includes a light emitting element EE. In an embodiment, for example, the light emitting element EE may be a micro organic light emitting diode (Micro-OLED).

The pixel receives a writing gate signal GW, an initialization gate signal GI, a light emitting element initialization gate signal EB, the data voltage VDATA and the emission signal EM and the light emitting element EE of the pixel emits light corresponding to the level of the data voltage VDATA to display the image.

In such an embodiment, the first switching element M1, the second switching element M2, the third switching element M3, the fourth switching element M4 and the fifth switching element M5 may be P-type transistors. In an embodiment, for example, the first fourth switching element M4 and the fifth switching element M5 may be low temperature polysilicon (LTPS) thin film transistors.

In such an embodiment, the sixth switching element M6 may be an N-type transistor. In an embodiment, for example, the sixth switching element M6 may be an oxide semiconductor thin film transistor.

According to an embodiment, the pixel may include the second switching element M2 having a diode-connection, the first capacitor C1 and the second capacitor C2.

In such an embodiment, the pixel may include the second switching element M2 having the diode-connection such that a variation of the threshold voltage of the driving switching element M1 and a variation of the threshold voltage of the light emitting element EE may be compensated.

In addition, the data swing range which is wider than the data range of the driving switching element M1 may be obtained due to the linearization effect of the second switching element M2. In addition, the data voltage VDATA is distributed by charge distribution of the first capacitor C1 and the second capacitor C2 such that the data swing range may be further expanded.

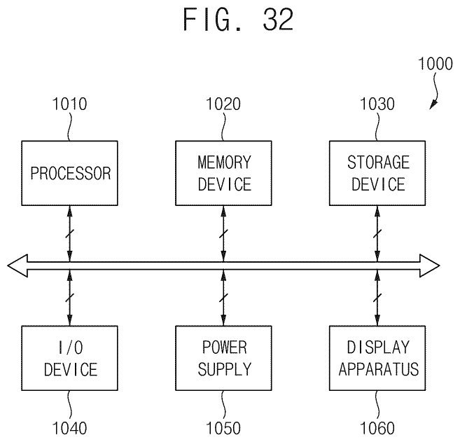

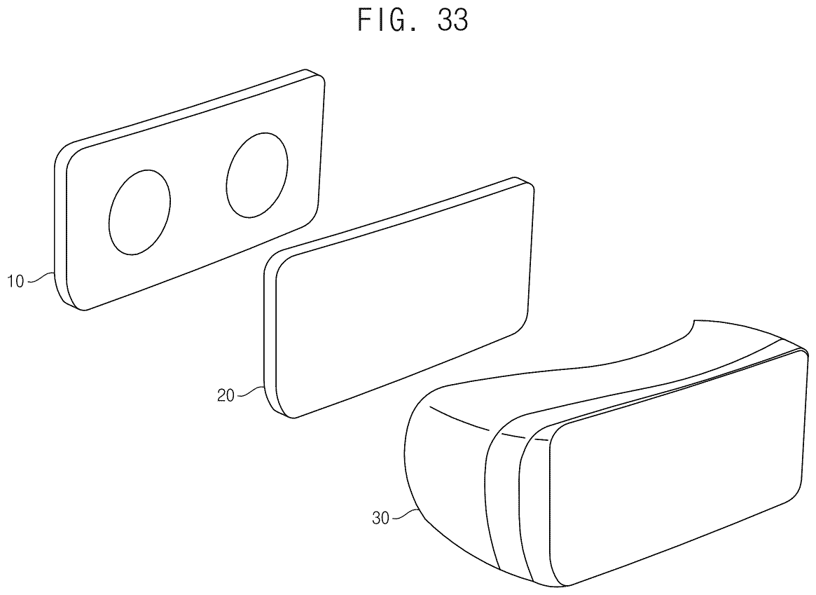

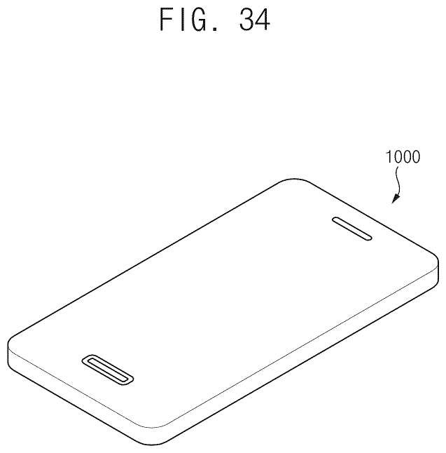

FIG. 32 is a block diagram illustrating an electronic apparatus according to an embodiment of the invention. FIG. 33 is a diagram illustrating an example in which the electronic apparatus of FIG. 32 is implemented as a virtual reality display system. FIG. 34 is a diagram illustrating an example in which the electronic apparatus of FIG. 32 is implemented as a smart phone.

Referring to FIGS. 1 to 34, the electronic apparatus 1000 may include a processor 1010, a memory device 1020, a storage device 1030, an input/output (I/O) device 1040, a power supply 1050, and a display apparatus 1060. In such an embodiment, the display apparatus 1060 may correspond to the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 34, the electronic apparatus 1000 may be implemented as a smart phone. However, the electronic apparatus 1000 is not limited thereto. In an embodiment, for example, the electronic apparatus 1000 may be implemented as a cellular phone, a video phone, a smart pad, a smart watch, a tablet computer, a car navigation system, a computer monitor, a laptop, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

Referring to FIG. 33, the virtual reality (VR) display system may include a lens 10, a display apparatus 20 and a housing 30. The display apparatus 20 may be disposed adjacent to the lens 10. The housing 30 may receive the lens 10 and the display apparatus 20. Although an embodiment where the lens 10 and the display apparatus 20 are received on a first side of the housing 30 is shown in FIG. 33, the invention may not be limited thereto. In another embodiment, for example, the lens 10 may be received on a first side of the housing 30 and the display apparatus 20 may be received on a second side of the housing 30 opposite to the first side of the housing 30. In an embodiment where the lens 10 and the display apparatus are received on opposite sides with respect to the housing 30, the housing 30 may have a transmitting portion to transmit a light.

In an embodiment, for example, the VR display system may be a head mounted display system worn on a user's head. Although not shown in figures, the VR display system may further include a head band to fix the VR display system to the user's head.

Alternatively, the VR display system may have a form of smart glasses designed as a shape of glasses.

In addition, the electronic apparatus may be implemented as an augmented reality (AR) display system for supporting an augmented reality. The AR display system may have a smartphone shape, a smart glasses shape, a head mounted display shape, etc., but may not be limited to those shapes.

In addition, the electronic apparatus may be implemented as a mixed reality (MR) display system for supporting a mixed reality. The MR display system may have a smartphone shape, a smart glasses shape, a head mounted display shape, etc., but may not be limited to those shapes.

According to embodiments of the display apparatus of the invention as described above, the data swing range may be increased and the uniformity may be enhanced.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel comprising:
a first switching element including a control electrode connected to a first node, a first electrode connected to a second node and a second electrode connected to a third node;
a second switching element including a control electrode connected to the second node, a first electrode connected to a fifth node and a second electrode connected to the second node;
a third switching element including a control electrode which receives a writing gate signal, a first electrode which receives a data voltage and a second electrode connected to the first node;
a first capacitor including a first electrode connected to the first node and a second electrode connected to a fourth node;
a second capacitor connected to the fourth node;
a fourth switching element which receives an initialization gate signal and connected to the fourth node; and
a light emitting element which emits light based on a driving current flowing thereto through the first switching element.

2. The pixel of claim 1, wherein the fourth switching element includes:
a control electrode which receives the initialization gate signal;
a first electrode which receives a first power voltage; and
a second electrode connected to the fourth node.

3. The pixel of claim 2, wherein the second capacitor includes:
a first electrode connected to the fourth node; and
a second electrode connected to the fifth node.

4. The pixel of claim 2, wherein the second capacitor includes:
a first electrode connected to the fourth node; and
a second electrode connected to the second node.

5. The pixel of claim 1, wherein the fourth switching element includes:
a control electrode which receives the initialization gate signal;
a first electrode connected to the fifth node; and
a second electrode connected to the fourth node.

6. The pixel of claim 5, wherein the second capacitor includes:
a first electrode connected to the fourth node; and
a second electrode connected to the fifth node.

7. The pixel of claim 5, wherein the second capacitor includes:
a first electrode connected to the fourth node; and
a second electrode connected to the second node.

8. The pixel of claim 1, wherein the fourth switching element includes:
a control electrode which receives the initialization gate signal;
a first electrode connected to the second node; and
a second electrode connected to the fourth node.

9. The pixel of claim 1, further comprising a fifth switching element including a control electrode which receives an emission signal, a first electrode which receives a first power voltage and a second electrode connected to the fifth node.

10. The pixel of claim 1, further comprising a sixth switching element including a control electrode which receives a light emitting element initialization gate signal, a first electrode which receives an initialization voltage and a second electrode connected to the third node.

11. The pixel of claim 10, further comprising a fifth switching element including a control electrode which receives an emission signal, a first electrode which receives a first power voltage and a second electrode connected to the fifth node,
wherein the first switching element, the second switching element, the third switching element, the fourth switching element, the fifth switching element and the sixth switching element are P-type transistors.

12. The pixel of claim 11, wherein breakdown voltages of the first switching element and the sixth switching element are greater than breakdown voltages of the second switching element, the third switching element, the fourth switching element and the fifth switching element.

13. The pixel of claim 10, further comprising a fifth switching element including a control electrode which receives an emission signal, a first electrode which receives a first power voltage and a second electrode connected to the fifth node,
wherein the first switching element, the second switching element, the third switching element, the fourth switching element and the fifth switching element are P-type transistors, and
wherein the sixth switching element is an N-type transistor.

14. The pixel of claim 10, further comprising a fifth switching element including a control electrode which receives an emission signal, a first electrode which receives a first power voltage and a second electrode connected to the fifth node,
wherein the initialization gate signal has an active level in a first period, the writing gate signal has an active level in the first period, the emission signal has an active level in the first period, the light emitting element initialization gate signal has an active level in the first period and the data voltage has a reference voltage in the first period,
wherein the initialization gate signal has an inactive level in a second period subsequent to the first period, the writing gate signal has the active level in the second period, the emission signal has an inactive level in the second period, the light emitting element initialization gate signal has the active level in the second period and the data voltage has a present grayscale data voltage in the second period, and
wherein the initialization gate signal has the inactive level in a third period subsequent to the second period, the writing gate signal has an inactive level in the third period, the emission signal has the active level in the third period and the light emitting element initialization gate signal has an inactive level in the third period.

15. The pixel of claim 10, further comprising a fifth switching element including a control electrode which receives an emission signal, a first electrode which receives a first power voltage and a second electrode connected to the fifth node,
wherein the initialization gate signal has an active level in a first period, the writing gate signal has an active level in the first period, the emission signal has an active level in the first period and the light emitting element initialization gate signal has an active level in the first period,
wherein the initialization gate signal has an inactive level in a second period subsequent to the first period, the writing gate signal has the active level in the second period, the emission signal has an inactive level in the second period and the light emitting element initialization gate signal has the active level in the second period, and
wherein the initialization gate signal has the inactive level in a third period subsequent to the second period, the writing gate signal has an inactive level in the third period, the emission signal is changed from the inactive level to the active level at a first time point subsequent to a start point of the third period and the light emitting element initialization gate signal is changed from the active level to an inactive level at a second time point subsequent to the start point of the third period.

16. The pixel of claim 10, further comprising a fifth switching element including a control electrode which receives an emission signal, a first electrode which receives a first power voltage and a second electrode connected to the fifth node,
wherein the initialization gate signal has an active level in a first period, the writing gate signal has an active level in the first period, the emission signal has an active level in the first period, the light emitting element initialization gate signal has an active level in the first period and the data voltage has a present grayscale data voltage in the first period,
wherein the initialization gate signal has an inactive level in a second period subsequent to the first period, the writing gate signal has the active level in the second period, the emission signal has an inactive level in the second period, the light emitting element initialization gate signal has the active level in the second period and the data voltage has the present grayscale data voltage in the second period, and
wherein the initialization gate signal has the inactive level in a third period subsequent to the second period, the writing gate signal has an inactive level in the third period, the emission signal has the active level in the third period and the light emitting element initialization gate signal has an inactive level in the third period.

17. The pixel of claim 1, wherein when I_{d} indicates a current flowing through the light emitting element, μₚ indicates a mobility of the first switching element, Cₒₓ indicates a capacitance of the first switching element, W/L indicates a ratio of a width and a length of a channel of the first switching element, VDD indicates a first power voltage, V_{dsat2} indicates a saturation voltage of the second switching element, Vₜₕ₂ indicates a threshold voltage of the second switching element, C₁ indicates a capacitance of the first capacitor, C₂ indicates a capacitance of the second capacitor, V_{DATA} indicates the data voltage, V_{REF} indicates a reference voltage, Vₜₕ₁ indicates a threshold voltage of the first switching element, gₘ indicates a trans-conductance of the first switching element and R_{dio} indicates a resistance of the second switching element,
$${I}_{d} = \frac{1}{2} {μ}_{p} {C}_{ox} \frac{W}{L} {( \frac{VDD - {V}_{dsat 2} - \vert {V}_{th 2} \vert - \frac{{C}_{1}}{{C}_{1} + {C}_{2}} \cdot ( {V}_{DATA} - {V}_{REF} )}{1 + {g}_{m} {R}_{dio}} - \vert {V}_{th 1} \vert )}^{2}$$
is satisfied.

18. The pixel of claim 1, further comprising a seventh switching element including a control electrode which receives a second initialization gate signal, a first electrode which receives a reference voltage and a second electrode connected to the first node.

19. The pixel of claim 18, further comprising:
a fifth switching element including a control electrode which receives an emission signal, a first electrode which receives a first power voltage and a second electrode connected to the fifth node; and
a sixth switching element including a control electrode which receives a light emitting element initialization gate signal, a first electrode which receives an initialization voltage and a second electrode connected to the third node,
wherein the initialization gate signal has an active level in a first period, the second initialization gate signal has an active level in the first period, the writing gate signal has an active level in the first period, the emission signal has an active level in the first period, the light emitting element initialization gate signal has an active level in the first period and the data voltage has the reference voltage in the first period,
wherein the initialization gate signal has an inactive level in a second period subsequent to the first period, the second initialization gate signal has an inactive level in the second period, the writing gate signal has the active level in the second period, the emission signal has an inactive level in the second period, the light emitting element initialization gate signal has the active level in the second period and the data voltage has a present grayscale data voltage in the second period, and
wherein the initialization gate signal has the inactive level in a third period subsequent to the second period, the second initialization gate signal has the inactive level in the third period, the writing gate signal has an inactive level in the third period, the emission signal has the active level in the third period and the light emitting element initialization gate signal has an inactive level in the third period.

20. A display apparatus comprising:
a display panel including a pixel;
a gate driver which outputs a gate signal to the pixel; and
a data driver which outputs a data voltage to the pixel,
wherein the pixel comprises:
a first switching element including a control electrode connected to a first node, a first electrode connected to a second node and a second electrode connected to a third node;
a second switching element including a control electrode connected to the second node, a first electrode connected to a fifth node and a second electrode connected to the second node;
a third switching element including a control electrode which receives a writing gate signal, a first electrode which receives the data voltage and a second electrode connected to the first node;
a first capacitor including a first electrode connected to the first node and a second electrode connected to a fourth node;
a second capacitor connected to the fourth node;
a fourth switching element which receives an initialization gate signal and connected to the fourth node; and
a light emitting element which emits light based on a driving current flowing thereto through the first switching element.

21. An electronic apparatus comprising:
a display panel including a pixel;
a gate driver which outputs a gate signal to the pixel;
a data driver which outputs a data voltage to the pixel;
a driving controller which controls the gate driver and the data driver; and
a processor which outputs input image data and an input control signal,
wherein the pixel comprises:
a first switching element including a control electrode connected to a first node, a first electrode connected to a second node and a second electrode connected to a third node;
a second switching element including a control electrode connected to the second node, a first electrode connected to a fifth node and a second electrode connected to the second node;
a third switching element including a control electrode which receives a writing gate signal, a first electrode which receives the data voltage and a second electrode connected to the first node;
a first capacitor including a first electrode connected to the first node and a second electrode connected to a fourth node;
a second capacitor connected to the fourth node;
a fourth switching element which receives an initialization gate signal and connected to the fourth node; and
a light emitting element which emits light based on a driving current flowing thereto through the first switching element.
